(19) United States
(12) Patent Application Publication
(10) Pub. No.: US 2013/0191768 A1
(43) Pub. Date: Jul. 25, 2013

(54) METHOD FOR MANIPULATING A GRAPHICAL OBJECT AND AN INTERACTIVE INPUT SYSTEM EMPLOYING THE SAME

(71) Applicant: Smart Technologies ULC, Calgary (CA)

(72) Inventors: SEAN WILLIAM ROBERT THOMPSON, Calgary (CA); MICHAEL LLOYD ROUNDING, Calgary (CA); KATHRYN KYLIE ROUNDING, Calgary (CA); DANIEL GREENBLATT, Calgary (CA); DAVID ROBERT MILFORD, Calgary (CA); JEFFREY ARTHUR TAYLOR, Calgary (CA); SHIH-CHEN MAN, Calgary (CA); XIAOMIN WU, Calgary (CA); THOMAS JOHN WILLEKES, Calgary (CA)

(73) Assignee: SMART TECHNOLOGIES ULC, Calgary (CA)

(21) Appl. No.: 13/738,330

(22) Filed: Jan. 10, 2013

Related U.S. Application Data
(60) Provisional application No. 61/585,063, filed on Jan. 10, 2012.

(51) Int. Cl. G06F 3/0481

(52) U.S. Cl. CPC G06F 3/0481
USPC 715/765

(57) ABSTRACT

A method comprises generating at least two input events in response to at least two contacts made by pointers on an interactive surface at a location corresponding to at least one graphical object; determining a pointer contact type associated with the at least two input events; determining the number of graphical objects selected; identifying a gesture based on the movement of the pointers; identifying a manipulation based on pointer contact type, number of graphical objects selected, movement of the pointers, and graphical object type; and performing the manipulation on the at least one graphical object.

### CROSS-REFERENCE TO RELATED APPLICATION

This application claims the benefit of U.S. Provisional Application No. 61/585,063 to Thompson et al. filed on Jan. 10, 2012, entitled “Method for Manipulating a Graphical Object and an Interactive Input System Employing the Same”, the entire disclosure of which is incorporated herein by reference.

### FIELD OF THE INVENTION

The present invention relates generally to interactive input systems, and in particular to a method for manipulating a graphical object and an interactive input system employing the same.

### BACKGROUND OF THE INVENTION

Interactive input systems that allow users to inject input such as for example digital ink, mouse events etc. into an application program using an active pointer (e.g. a pointer that emits light, sound or other signal), a passive pointer (e.g., a finger, cylinder or other object) or other suitable input device such as for example, a mouse or trackball, are well known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 and in U.S. Patent Application Publication No. 2004/0179001, all assigned to SMART Technologies ULC of Calgary, Alberta, Canada, assignee of the subject application, the entire disclosures of which are incorporated herein by reference; touch systems comprising touch panels employing electromagnetic, capacitive, acoustic or other technologies to register pointer input; tablet and laptop personal computers (PCs); smartphones; personal digital assistants (PDAs) and other handheld devices; and other similar devices.

Gesture recognition has been widely used in interactive input systems to enhance a user's ability to interact with displayed images. For example, one known gesture involves applying two pointers on a displayed graphical object (e.g., an image) and moving the two pointers apart from each other in order to zoom-in on the graphical object. While gestures are useful, there is still a lack of a systematic method of defining gestures in an intuitive and consistent manner. As a result, users have to memorize each individual gesture they want to use. Also, as more and more gestures are defined, it becomes a burden for users to memorize them. Moreover, some gestures may conflict with each other, or may be ambiguous such that a slight inaccuracy in gesture input may cause the interactive input system to interpret the input gesture as a completely different gesture than the one intended.

Accordingly, improvements are desired. It is therefore an object to provide a novel method for manipulating a graphical object and a novel interactive input system employing the same.

### SUMMARY OF THE INVENTION

Accordingly, in one aspect there is provided a method comprising generating at least two input events in response to at least two contacts made by pointers on an interactive surface at a location corresponding to at least one graphical object; determining a pointer contact type associated with the at least two input events; determining the number of graphical objects selected; identifying a gesture based on the movement of the pointers; identifying a manipulation based on pointer contact type, number of graphical objects selected, movement of the pointers, and graphical object type; and performing the manipulation on the at least one graphical object.

In one embodiment, the at least two contacts on the interactive surface are made by at least two fingers or at least two pen tools configured to a cursor mode. Identifying the manipulation comprises looking up the pointer contact type, number of graphical objects selected, the graphical object type and the identified gesture in a lookup table. The lookup table may be customizable by a user. In one form, the graphical object type is one of an embedded object, a file tab, a page thumbnail and a canvas zone.

In one fore, when the graphical object type is an embedded object, the manipulation is one of cloning, grouping, ungrouping, locking, unlocking and selecting. In another form, when the graphical object type is a file tab, the manipulation is cloning. In another form, when the graphical object type is a page thumbnail, the manipulation is one of cloning, moving to the next page thumbnail, moving to the previous page thumbnail and cloning to resize to fit a canvas zone. In another form, when the graphical object type is a canvas zone, the manipulation is one of moving to the next page, moving to the previous page, cloning, opening a file and saving a file.

The pointer contact type in one embodiment is one of simultaneous and non-simultaneous. In one form, when the pointer contact type is simultaneous, the gesture identified is one of dragging, shaking and holding. In another form, when the pointer contact type is non-simultaneous, the gesture is identified as one of hold and drag, and hold and tap.

In one embodiment, the method further comprises identifying a graphical object on which the gesture starts and identifying a graphical object on which the gesture ends. Identifying the manipulation comprises looking up the pointer contact type, the number of graphical objects selected, the graphical object type, the graphical object on which the gesture starts, the graphical object on which the gesture ends and the identified gesture in a lookup table.

According to another aspect there is provided an interactive input system comprising an interactive surface; and processing structure configured to receive at least two input events in response to at least two contacts made by pointers on the interactive surface at a location corresponding to at least one graphical object, said processing structure being configured to determine a pointer contact type associated with the at least two input events, determine the number of graphical objects selected, identify a gesture based on the movement of the pointers, identify a manipulation based on the pointer contact type, number of graphical objects selected, movement of the pointers, and graphical object type, and perform the manipulation on the at least one graphical object.

According to another aspect there is provided a non-transitory computer readable medium embodying a computer program for execution by a computing device, the computer program comprising program code for generating at least two input events in response to at least two contacts made by pointers on an interactive surface at a location corresponding to at least one graphical object; program code for determining a pointer contact type associated with the at least two input events; program code for determining the number of graphical objects selected; program code for identifying a gesture based on movement of the pointers; program code for identifying a manipulation based on pointer contact type, number of graphical objects selected, movement of the pointers, and graphical object type; and program code for performing the manipulation on the at least one graphical object.

### BRIEF DESCRIPTION OF THE DRAWINGS

Embodiments will now be described more fully with reference to the accompanying drawings in which:

FIG. 1A is a perspective view of an interactive input system;

FIG. 1B is a simplified block diagram of the software architecture of the interactive input system of FIG. 1;

FIG. 2 illustrates an exemplary graphic user interface displayed on an interactive surface of the interactive input system of FIG. 1;

FIG. 3A is a flowchart showing a method executed by a general purpose computing device of the interactive input system of FIG. 1 for identifying a manipulation to be performed on a displayed graphical object;

FIG. 3B is a flowchart showing a method for manipulating a displayed graphical object;

FIG. 4 is a flowchart showing a method for determining pointer contact type for a pointer in contact with the interactive surface of the interactive input system of FIG. 1;

FIGS. 5A and 5B are flowcharts showing a method for recognizing a multi-touch gesture involving two pointers simultaneously and non-simultaneously in contact with the interactive surface of the interactive input system of FIG. 1, respectively;

FIGS. 6A and 6B show an exemplary lookup table;

FIGS. 7A and 7B show an example of manipulating an embedded object according to the method of FIG. 3B;

FIGS. 8A and 8B show an example of manipulating a page thumbnail according to the method of FIG. 3B;

FIGS. 9A and 9B show another example of manipulating a page thumbnail according to the method of FIG. 3B;

FIGS. 10A and 10B show an example of cloning a tab according to the method of FIG. 3B;

FIGS. 11A and 11B show an example of switching a current page to the next page according to the method of FIG. 3B;

FIGS. 11C and 11D show an example of switching the current page to the previous page according to the method of FIG. 3B;

FIGS. 12A and 12B show an example of grouping a selected number of graphical objects according to the method of FIG. 3B;

FIGS. 12C and 121D show an example of ungrouping a selected number of graphical objects according to the method of FIG. 3B;

FIGS. 13A, 13B and 13C show an example of clearing content on a canvas according to the method of FIG. 3B;

FIGS. 14A and 14B show an example of manipulating digital ink according to the method of FIG. 3B;

FIGS. 15A and 15B show an example of opening a file according to the method of FIG. 3B;

FIGS. 16A, 16B and 16C show another example of manipulating an embedded object according to method of FIG. 3B;

FIGS. 17A and 17B show an example of locking an embedded object according to the method of FIG. 3B;

FIGS. 17C and 17D show an example of unlocking an embedded object according to the method of FIG. 3B;

FIGS. 18A and 18B show an example of selecting embedded objects according to the method of FIG. 3B;

FIGS. 19A and 19B show an example of saving a file according to the method of FIG. 3B;

FIGS. 20A and 20B show another example of switching the current page to the next page according to the method of FIG. 3B;

FIG. 21 shows a method for recognizing a multi-touch gesture involving two pointers simultaneously in contact with the interactive surface of the interactive input system of FIG. 1; and

FIGS. 22A and 22B show an example of implementing the method of FIG. 3B in the event the pointers are in ink mode.

### DETAILED DESCRIPTION OF THE EMBODIMENTS

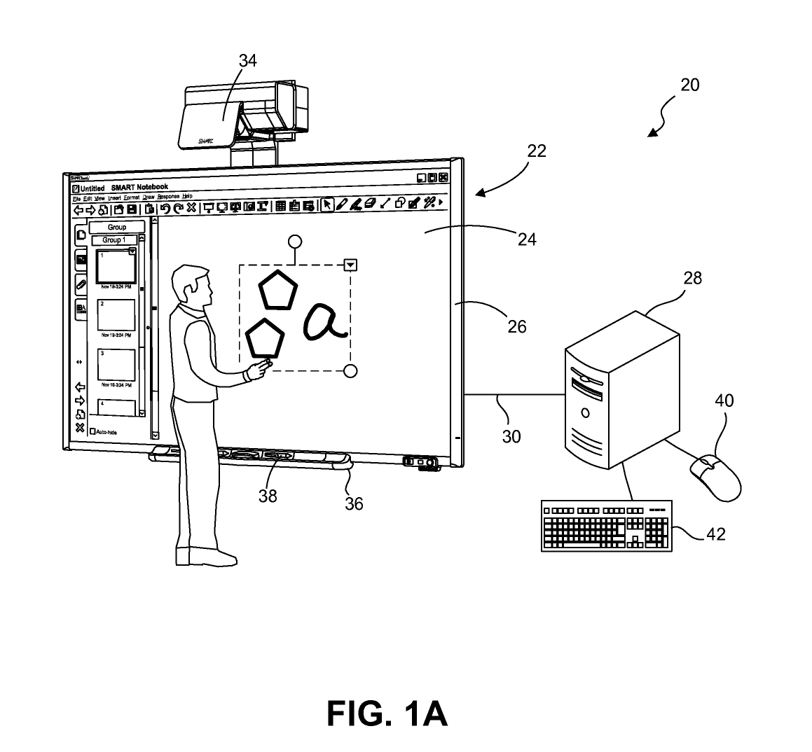

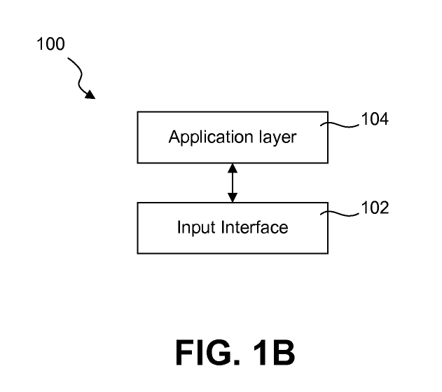

Turning now to FIG. 1A, an interactive input system is shown and is generally identified by reference numeral 20. Interactive input system 20 allows one or more users to inject input such as digital ink, mouse events, commands, etc. into an executing application program. In this embodiment, interactive input system 20 comprises a two-dimensional (2D) interactive device in the form of an interactive whiteboard (IWB) 22 mounted on a vertical support surface such as for example, a wall surface or the like or otherwise suspended or supported in an upright manner. IWB 22 comprises a generally planar, rectangular interactive surface 24 that is surrounded about its periphery by a bezel 26. An ultra-short-throw projector 34 such as that sold by SMART Technologies ULC, assignee of the subject application, under the name “SMART UX60”, is also mounted on the support surface above the IWB 22 and projects an image, such as for example, a computer desktop, onto the interactive surface 24.

The IWB 22 employs machine vision to detect one or more pointers brought into a region of interest in proximity with the interactive surface 24. The IWB 22 communicates with a general purpose computing device 28 executing one or more application programs via a universal serial bus (USB) cable 30 or other suitable wired or wireless communication link. General purpose computing device 28 processes the output of the IWB 22 and adjusts image data that is output to the projector 34, if required, so that the image presented on the interactive surface 24 reflects pointer activity. In this manner, the IWB 22, general purpose computing device 28 and projector 34 allow pointer activity proximate to the interactive surface 24 to be recorded as writing or drawing or used to control execution of one or more application programs executed by the general purpose computing device 28.

The bezel 26 is mechanically fastened to the interactive surface 24 and comprises four bezel segments that extend along the edges of the interactive surface 24. In this embodiment, the inwardly facing surface of each bezel segment comprises a single, longitudinally extending strip or band of retro-reflective material. To take best advantage of the properties of the retro-reflective material, the bezel segments are oriented so that their inwardly facing surfaces lie in a plane generally normal to the plane of the interactive surface 24.

A tool tray 36 is affixed to the IWB 22 adjacent the bottom bezel segment using suitable fasteners such as for example, screws, clips, adhesive etc. As can be seen, the tool tray 36 comprises a housing having an upper surface configured to define a plurality of receptacles or slots. The receptacles are sized to receive one or more pen tools 38 as well as an eraser tool that can be used to interact with the interactive surface 24. Control buttons are also provided on the upper surface of the tool tray housing to enable a user to control operation of the interactive input system 20. Further specifies of the tool tray 36 are described in International PCT Application Publication No. WO 2011/085486 to Bolt et al., filed on Jan. 13, 2011, and entitled “INTERACTIVE INPUT SYSTEM AND TOOL TRAY THEREFOR”, the disclosure of which is incorporated herein by reference in its entirety.

Imaging assemblies (not shown) are accommodated by the bezel 26, with each imaging assembly being positioned adjacent a different corner of the bezel. Each of the imaging assemblies comprises an image sensor and associated lens assembly that provides the image sensor with a field of view sufficiently large as to encompass the entire interactive surface 24. A digital signal processor (DSP) or other suitable processing device sends clock signals to the image sensor causing the image sensor to capture image frames at the desired frame rate. During image frame capture, the DSP also causes an infrared (IR) light source to illuminate and flood the region of interest over the interactive surface 24 with IR illumination. Thus, when no pointer exists within the field of view of the image sensor, the image sensor sees the illumination reflected by the retro-reflective bands on the bezel segments and captures image frames comprising a continuous bright band. When a pointer exists within the field of view of the image sensor, the pointer occludes reflected IR illumination and appears as a dark region interrupting the bright band in captured image frames.

The imaging assemblies are oriented so that their fields of view overlap and look generally across the entire interactive surface 24. In this manner, any pointer such as for example a user's finger, a cylinder or other suitable object, a pen tool 38 or an eraser tool lifted from a receptacle of the tool tray 36, that is brought into proximity of the interactive surface 24 appears in the fields of view of the imaging assemblies and thus, is captured in image frames acquired by multiple imaging assemblies. When the imaging assemblies acquire image frames in which a pointer exists, the imaging assemblies convey pointer data to the general purpose computing device 28.

The general purpose computing device 28 in this embodiment is a personal computer or other suitable processing device comprising, for example, a processing unit, system memory (volatile and/or non-volatile memory), other non-removable or removable memory (e.g., a hard disk drive, RAM, ROM, EEPROM, CD-ROM, DVD, flash memory, etc.) and a system bus coupling the various computer components to the processing unit. The general purpose computing device 28 may also comprise networking capabilities using Ethernet, WiFi, and/or other suitable network format, to enable connection to shared or remote drives, one or more networked computers, or other networked devices. A mouse 40 and a keyboard 42 are coupled to the general purpose computing device 28.

The general purpose computing device 28 processes pointer data received from the imaging assemblies to resolve pointer ambiguity by combining the pointer data detected by the imaging assemblies, and to compute the locations of pointers proximate the interactive surface 24 (sometimes referred as “pointer contacts”) using well known triangulation. The computed pointer locations are then recorded as writing or drawing or used as an input command to control execution of an application program as described above.

In addition to computing the locations of pointers proximate to the interactive surface 24, the general purpose computing device 28 also determines the pointer types (e.g., pen tool, finger or palm) by using pointer type data received from the IWB 22. The pointer type data is generated for each pointer contact by at least one of the imaging assembly DSPs by differentiating a curve of growth derived from a horizontal intensity profile of pixels corresponding to each pointer tip in captured image frames. Specifics of methods used to determine pointer type are disclosed in U.S. Pat. No. 7,532,206 to Morrison, et al., and assigned to SMART Technologies ULC, the disclosure of which is incorporated herein by reference in its entirety.

FIG. 1B shows exemplary software architecture used by the interactive input system 20, and which is generally identified by reference numeral 100. The software architecture 100 comprises an input interface 102, and an application layer comprising one or more application programs 104. The input interface 102 is configured to receive input from the various input sources of the interactive input system 20. In this embodiment, the input sources include the IWB 22, the mouse 40, and the keyboard 42. The input interface 102 processes received input and generates input events.

In generating each input event, the input interface 102 generally detects the identity of the received input based on input characteristics. Input interface 102 assigns to each input event, an input ID, a surface ID, and a contact ID as depicted in Table 1 below.

TABLE 1

| Input Source | IDs of Input Event |
|---|---|
| Keyboard | {input ID, NULL, NULL} |
| Mouse | {input ID, NULL, NULL} |
| Pointer contact on IWB | {input ID, surface ID, contact ID} |

In this embodiment, if the input is not pointer input originating from the IWB 22, the values of the surface ID and the contact ID are set to NULL.

The input ID identifies the input source. If the input originates from an input device such as mouse 40 or keyboard 42, the input ID identifies that input device. If the input is a pointer input originating from the IWB 22, the input ID identifies the type of pointer, such as for example a pen tool 38, a finger or a palm.

The surface ID identifies the interactive surface on which the pointer input is received. In this embodiment, IWB 22 comprises only a single interactive surface 24, and therefore the value of the surface ID is the identity of the interactive surface 24.

The contact ID is used to distinguish multiple simultaneous contacts made by the same type of pointer on the interactive surface 24. Contact IDs identify how many pointers are used, and permit tracking of each pointer's movement individually.

The interactive input system 20 uses input ID to distinguish users. That is, input events having different input IDs are considered as input events from different users. For example, an input event generated from a pen tool 38 (input ID is “pen tool”) and an input event generated from a finger (input ID is “finger”) are considered as being generated by different users.

As one or more pointers contact the interactive surface 24 of the IWB 22, associated input events are generated. The input events are generated from the time the one or more pointers are brought into contact with the interactive surface 24 (referred to as a contact down event) until the time the one or more pointers are lifted from the interactive surface 24 (referred to as a contact up event). As will be appreciated, a contact down event is similar to a mouse down event in a typical graphical user interface utilizing mouse input, wherein a user presses the left mouse button. Similarly, a contact up event is similar to a mouse up event in a typical graphical user interface utilizing mouse input, wherein a user releases the pressed mouse button. A contact move event is generated when a pointer is contacting and moving on the interactive surface 24, and is similar to a mouse drag event in a typical graphical user interface utilizing mouse input, wherein a user moves the mouse while pressing and holding the left mouse button.

The input interface 102 receives and processes input received from the input devices to retrieve associated IDs (input IDs, surface IDs, contact IDs). The input interface 102 generates input events and communicates each input event and associated IDs to the application program 104 for processing.

In this embodiment, the application program 104 is SMART Notebook™ offered by SMART Technologies ULC. As is known, SMART Notebook™ allows users to manipulate Notebook files. A Notebook file comprises one or more pages, and each page comprises a canvas and various graphical objects thereon, such as for example, text, images, digital ink, shapes, Adobe Flash objects, etc. As shown in FIG. 2, when executed, SMART Notebook™ causes a graphic user interface 142 to be presented in an application window 144 on the interactive surface 24. The application window 144 comprises a border 146, a title bar 148, a tab bar 150 having one or more tabs 152, each of which indicates a file opened by SMART Notebook™, a menu bar 154, a toolbar 156 comprising one or more tool buttons 158, a canvas zone 160 for displaying a Notebook™ page and for injecting graphical objects such as for example, digital ink, text, images, shapes, Flash objects, etc. thereon, and a page sorter 164 for displaying thumbnails 166 of Notebook™ pages. In the following, input events applied within the tab bar 150, canvas zone 160 or page sorter 164 will be discussed. Input events applied to other parts of the Notebook™ window are processed in a well-known manner for operating menus, tool buttons or the application window, and as such will not be described herein.

Different users are able to interact simultaneously with the interactive input system 20 via IWB 22, mouse 40 and keyboard 42 to perform a number of operations such as for example injecting digital ink or text and manipulating graphical objects. In the event one or more users contact the IWB 22 with a pointer, the mode of the pointer is determined as being either in the cursor mode or the ink mode. The interactive input system 20 assigns each pointer a default mode based on the input ID. For example, a finger in contact with the interactive surface 24 is assigned the cursor mode by default while a pen tool in contact with the interactive surface 24 is assigned the ink mode by default. In this embodiment, the application program 104 (SMART Notebook™) permits a user to change the mode assigned to the pointer by selecting a respective tool button 158 on the tool bar 156. For example, in the event a user wishes to inject digital ink into the application program 104 using their finger, the user may select a tool button associated with the ink mode on the tool bar 156. Similarly, in the event a user wishes to use a pen tool 38 in the cursor mode, the user may select a tool button associated with the cursor mode on the tool bar 156.

The application program 104 processes input events received from the input interface 102 to recognize gestures based on the movement of one or more pointers in contact with the interactive surface 24. In this embodiment, a gesture is recognized by the application program 104 by grouping input events having the same input ID and pointer mode (cursor mode or ink mode). As such, the application program 104 is able to identify gestures made by different users, simultaneously. The application program 104 recognizes both single-touch gestures performed using a single pointer and multi-touch gestures performed using two or more pointers. A gesture is a series of input events that match a set of predefined rules and are identified based on a number of criterion such as for example pointer contact type (simultaneous or non-simultaneous), the object from which the gesture starts, the object from which the gesture ends, the position on the object from which the gesture starts, the position on the graphical object from which the gesture ends, the movement of the pointers, etc.

An exemplary method will now be described for manipulating one or more graphical objects based on pointer contact type, the number of graphical objects selected, the graphical object type, the graphical object from which the gesture starts, the graphical object from which the gesture ends, and the gesture performed, wherein each contact described is a finger contacting the interactive input surface 24. As will be appreciated, a graphical object is an object displayed on the interactive input surface 24 which in this embodiment is an object associated with SMART Notebook™ such as for example a page thumbnail displayed in the page sorter 164, the canvas 160, or an embedded object in the canvas (e.g., an image, digital ink, text, a shape, a Flash object, etc.).

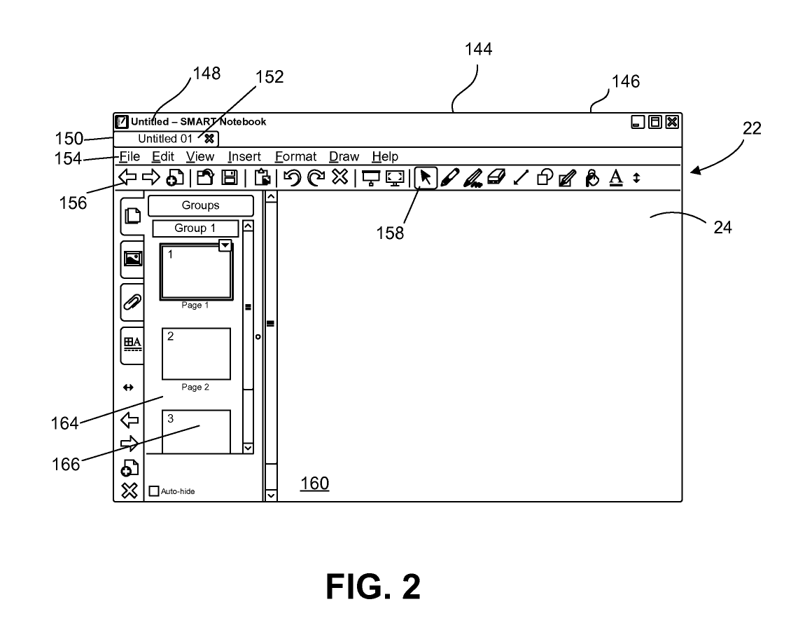

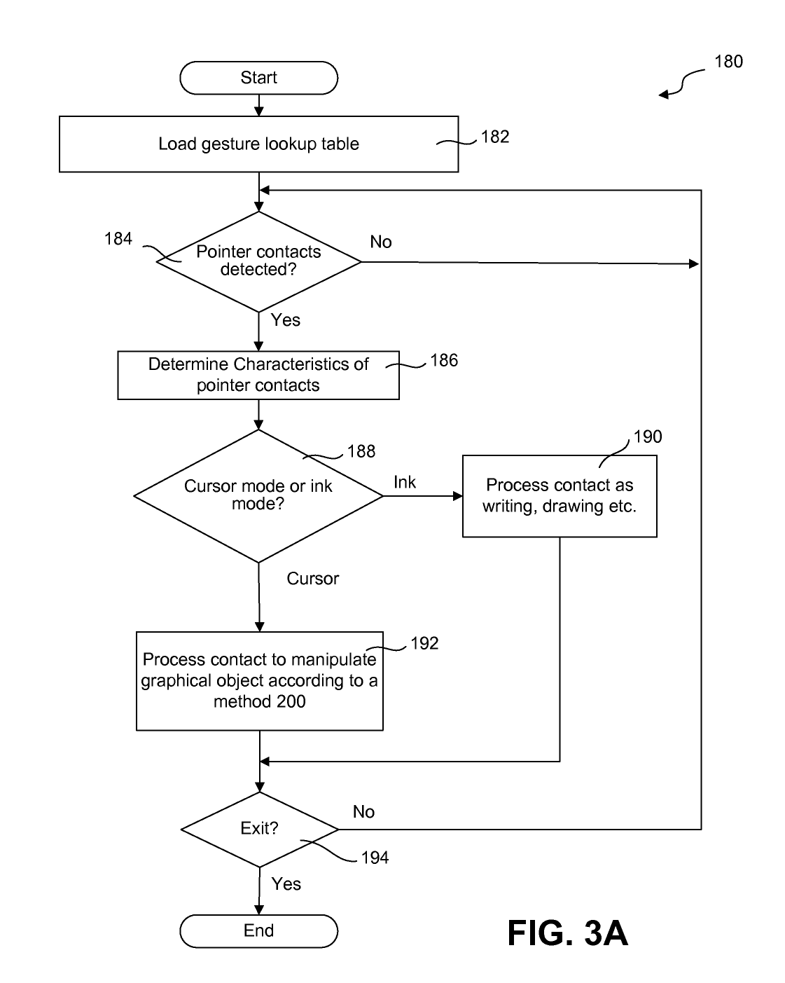

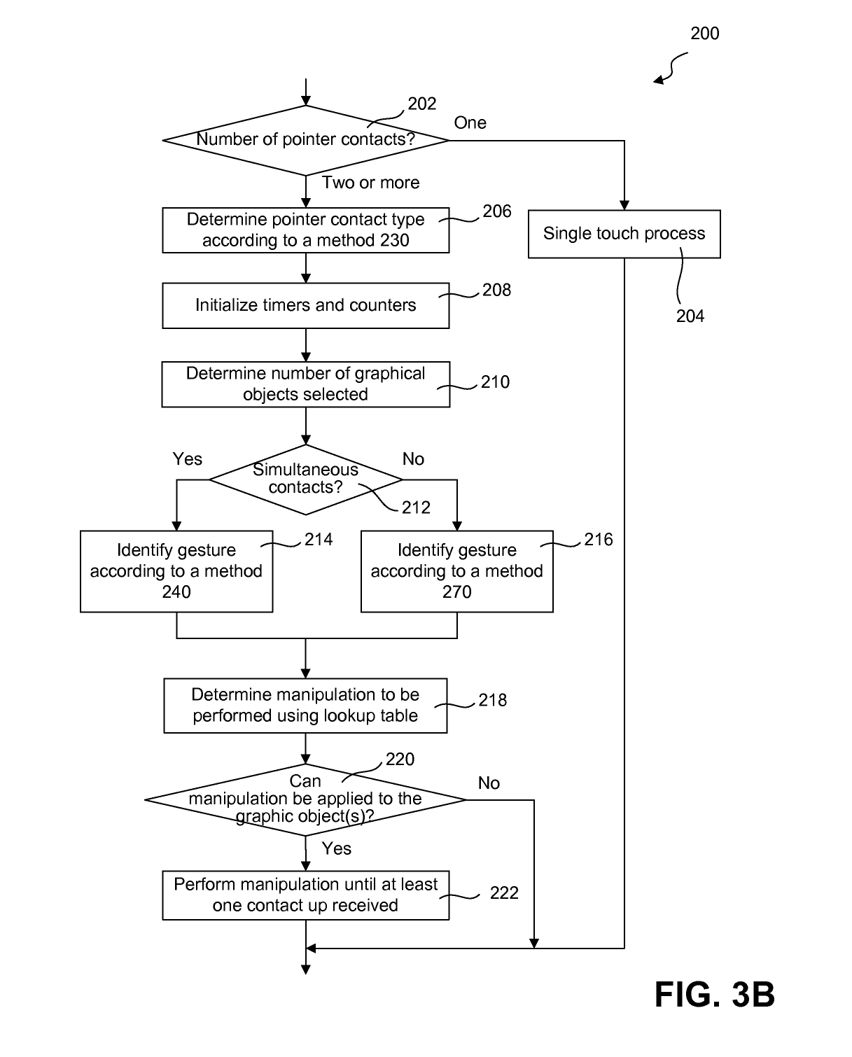

Turning now to FIG. 3A, the exemplary method executed by the general purpose computing device 28 of the interactive input system 20 is shown and is generally identified by reference numeral 180. Initially a lookup table is loaded. The lookup table (hereinafter referred to as a predefined lookup table, the details of which are discussed below) associates pointer contact type, the number of graphical objects selected, the graphical object type, the graphical object from which the gesture starts, the graphical object from which the gesture ends, and the gesture performed with the manipulation to be performed (step 182). The method then remains idle until a pointer contact on the interactive surface 24 is detected. In the event one or more contacts are detected on the interactive surface 24 (step 184), the characteristics of each contact on the interactive surface 24 are determined, such as for example the location of the contact, the mode of the pointer associated with the contact (cursor mode or ink mode) and the associated ID (step 186). A check is performed to determine if the pointer associated with each contact is in the cursor mode or the ink mode (step 188). In this embodiment, in the event the pointer is in the ink mode, the contact is processed as writing or drawing or used to control the execution of one or more application programs executed by the general purpose computing device 28 (step 190). In the event the pointer is in the cursor mode, the contact is processed to manipulate the graphical object according to method 200 (step 192) as will be described. Once the detected contact is processed according to step 190 or 192, the method determines if an exit condition has been detected (step 234). In the event no exit condition has been detected, the method returns to step 184 awaiting the next contact. In the event an exit condition has been detected, method 180 is terminated.

Turning now to FIG. 3B, the steps of method 200 performed at step 192 are shown. As can be seen, the method 200 begins by determining the number of pointers in contact with the interactive surface 24 (step 202). In the event a single pointer is in contact with the interactive surface 24 and a contact move event or a contact up event has been received, the single pointer contact is processed and a single pointer manipulation such as for example drag and drop, tapping, double tapping, etc. is performed on the graphical object, as is well known (step 204), and the method ends. In the event a single pointer is in contact with the interactive surface 24, and no contact move event or contact up event has been received, the method ends and returns to step 194 of method 180. As mentioned previously, in the event no exit condition has been received at step 194, the method returns to step 184 awaiting the next contact. However, if a second contact is detected while the (first) single pointer contact is still in contact with the interactive surface 24, method 200 is executed and at step 202, the number of pointer contacts is determined to be two.

At step 202, in the event two or more pointers are in contact with the interactive surface 24, the application program 104 determines the pointer contact type as simultaneous or non-simultaneous according to a method 230 (step 206) as will be described. The application program 104 then initializes a holding timer, a move timer and a move counter to a value of zero (step 208). The application program 104 then determines the number of graphical objects selected (step 210). As will be appreciated, in the event no graphical object has been previously selected by the user (via a selection gesture), the graphical object corresponding to the location of the contacts is assumed to be the graphical object selected. A check is performed to determine if the pointer contact type is simultaneous or non-simultaneous, as determined in step 206 (step 212). In the event the pointer contact type is simultaneous, the application program 104 analyzes the movement of the pointers on the interactive surface 24 and identifies the type of gesture performed according to a method 240 (step 214) as will be described. In the event the pointer contact type is non-simultaneous, the application program 104 analyzes the movement of the pointers on the interactive surface 24 and identifies the type of gesture performed according to a method 270 (step 216) as will be described. The application program 104 searches the predefined lookup table using the pointer contact type, the number of graphical objects selected, the graphical object type(s), the graphical object(s) from which the gesture starts, the graphical object(s) from which the gesture ends, and the gesture performed to determine the type of manipulation to be performed (step 218). The application program 104 then checks if the manipulation can be applied to the graphical object(s) (step 220). If the manipulation cannot be applied to the selected graphical object(s), for example if the graphical object is locked, method 200 ends. If the manipulation can be applied to the selected graphical object(s), the manipulation is performed on the selected graphical object(s) until at least one contact up event is received, indicating the end of the gesture (step 222) and the method 200 ends.

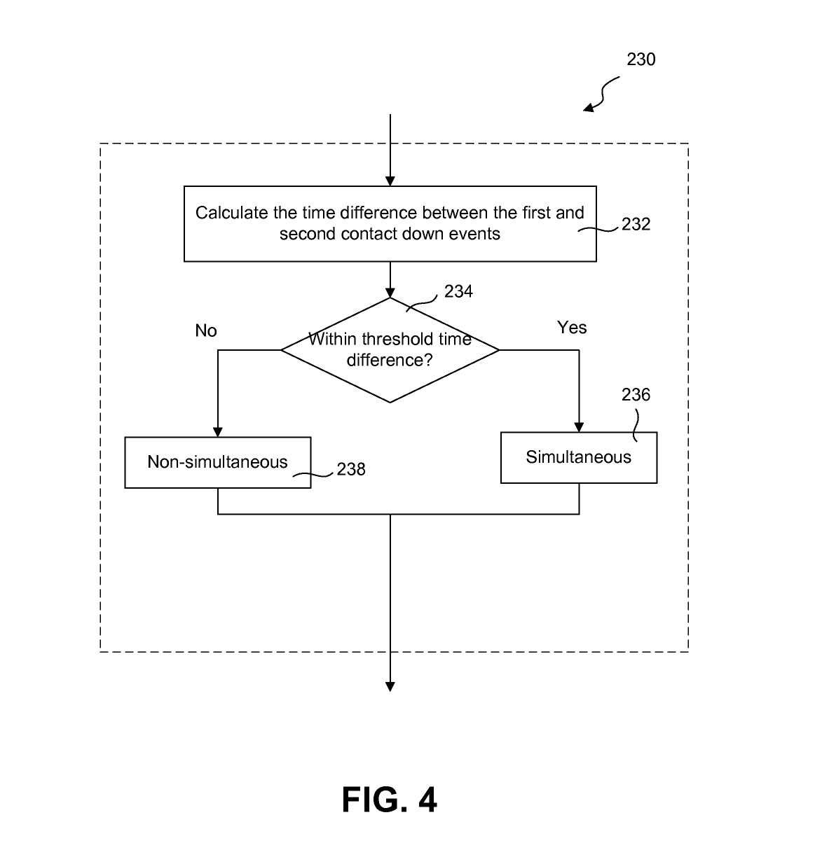

As mentioned previously, pointer contact type is determined as either simultaneous or non-simultaneous according to method 230. Turning now to FIG. 4, method 230 for determining the pointer contact type is shown. For ease of description, a scenario in which two pointers are brought into contact with the interactive surface 24 will be described, however as will be appreciated, a similar method is applied in scenarios where more than two pointers are brought into contact with the interactive surface 24. As mentioned previously, each time a pointer is brought into contact with the interactive surface 24, a contact down event is generated. As such, in the event two pointers are brought into contact with the interactive surface 24, a first contact down event and a second contact down event are generated. Method 230 begins by calculating the time difference between the first and second contact down events (step 232). The time difference is compared to a threshold time difference value, which in this embodiment is one (1) second (step 234). If the time difference is less than or equal to the threshold time difference value, it is determined that the two pointers have been brought into contact with the interactive surface 24 at approximately the same time, and thus the pointer contact type is simultaneous (step 236) and the method 230 ends. If the time difference is greater than the threshold time difference value, it is determined that the two pointers have been brought into contact with the interactive surface 24 at different times, and thus the pointer contact type is non-simultaneous (step 238) and the method 230 then ends.

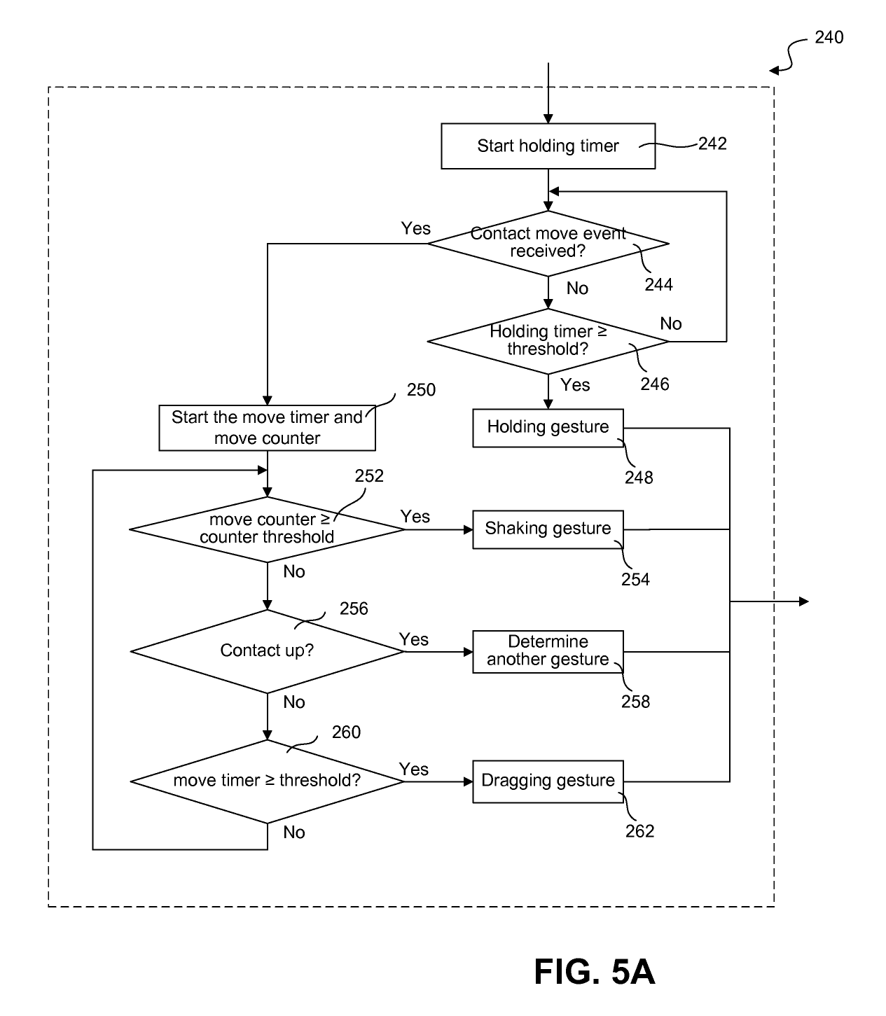

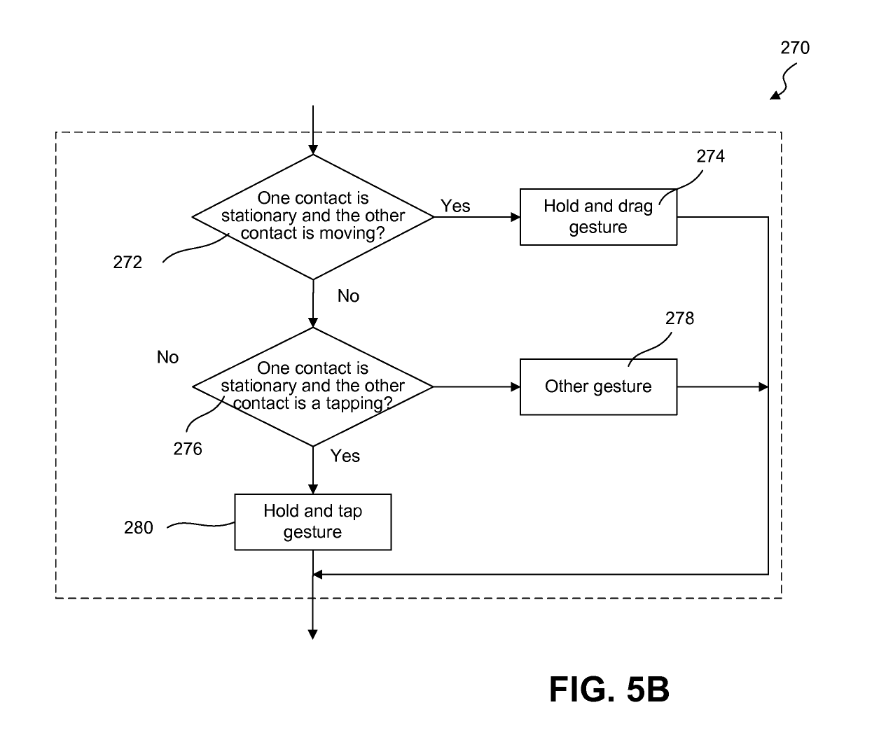

As mentioned previously, in the event the pointer contact type is determined to be simultaneous, a gesture is identified according to method 240. A number of different types of simultaneous gestures are identified by application program 104 such as for example a dragging gesture, a shaking gesture, and a holding gesture. Although not shown, it will be appreciated that in the event a gesture is not recognized by the application program 104, the gesture is ignored. Turning to FIG. 5A, method 240 for recognizing a multi-touch gesture made by two pointers simultaneously contacting the interactive surface 24 as a holding gesture, a dragging gesture or a shaking gesture is shown. In the event two contact down events are received, a holding timer is started (step 242). The holding timer measures the time elapsed since contact down events have been received. A check is performed to determine if any contact move events have been received (step 244). If no contact move events have been received, the holding timer is compared to a threshold, which in this embodiment is set to a value of three (3) seconds. If the holding timer is greater than or equal to the threshold, the gesture is identified as a holding gesture (step 246) and the method ends. If the holding timer is less than the threshold, the method returns to step 244. If, at step 244, a contact move event has been received, a move timer and a move counter are started (step 250). The move timer measures the elapsed time during performance of the movement gesture, and the counter counts the number of turns made, that is, the number of times the direction of pointer movement has changed approximately 180° during performance of the gesture. The counter is compared to a counter threshold, which in this embodiment is set to a value of (3) three (step 252). If the counter is greater than or equal to the counter threshold, that is, there has been three or more turns made during movement of the pointers, the gesture is identified as a shaking gesture (step 254) and the method ends. If the counter is less than the counter threshold, a check is performed to determine if a contact up event has been received (step 256). If a contact up event is determined to have been received, the gesture is determined to have been completed and the method determines another type of gesture based on the pointer movement (step 258). If a contact up event has not been received, the move timer is compared to a threshold which in this embodiment is set to a value of four (4) seconds (step 260). If the timer is less than the gesture timer threshold, the method returns to step 252. If the move timer is greater than or equal to the gesture timer threshold, the gesture is identified as a dragging gesture wherein the pointer is tracked on the interactive surface 24 (step 262) and the method ends.

As mentioned previously, in the event the pointer contact type is determined to be non-simultaneous, a gesture is identified according to method 270. A number of different types of non-simultaneous gestures are identified by application program 104 such as for example a hold and drag gesture and a hold and tap gesture. Although not shown, it will be appreciated that in the event a gesture is not recognized by the application program 104, the gesture is ignored. Turning to FIG. 5B, method 270 for recognizing a multi-touch gesture made by two pointers non-simultaneously contacting the interactive surface 24 as a hold and drag gesture or as a hold and tap gesture is shown. A check is performed to determine if one of the contacts is stationary and the other of the contacts is moving along the interactive surface 24 (step 272) and if so, the gesture is identified as a hold and drag gesture (step 274), and the method ends. If it is determined that one of the contacts is not moving along the interactive surface 24 or one of the contacts is not stationary on the interactive surface 24, a check is performed to determine if one of the contacts is stationary and the other of the contacts is tapping on the interactive surface 24 (step 276). In this embodiment, tapping is identified when the time between a contact down event and a contact up event received for a contact is less than a threshold value. As will be appreciated, tapping may occur once or a plurality of times. If one of the contacts is not tapping on the interactive surface 24 or if one of the contacts is not stationary on the interactive surface 24, the gesture is identified as another type of gesture (step 278), and the method ends. If one of the contacts is stationary and the other of the contacts is tapping on the interactive surface, the gesture is identified as a hold and tap gesture (step 280), and the method ends.

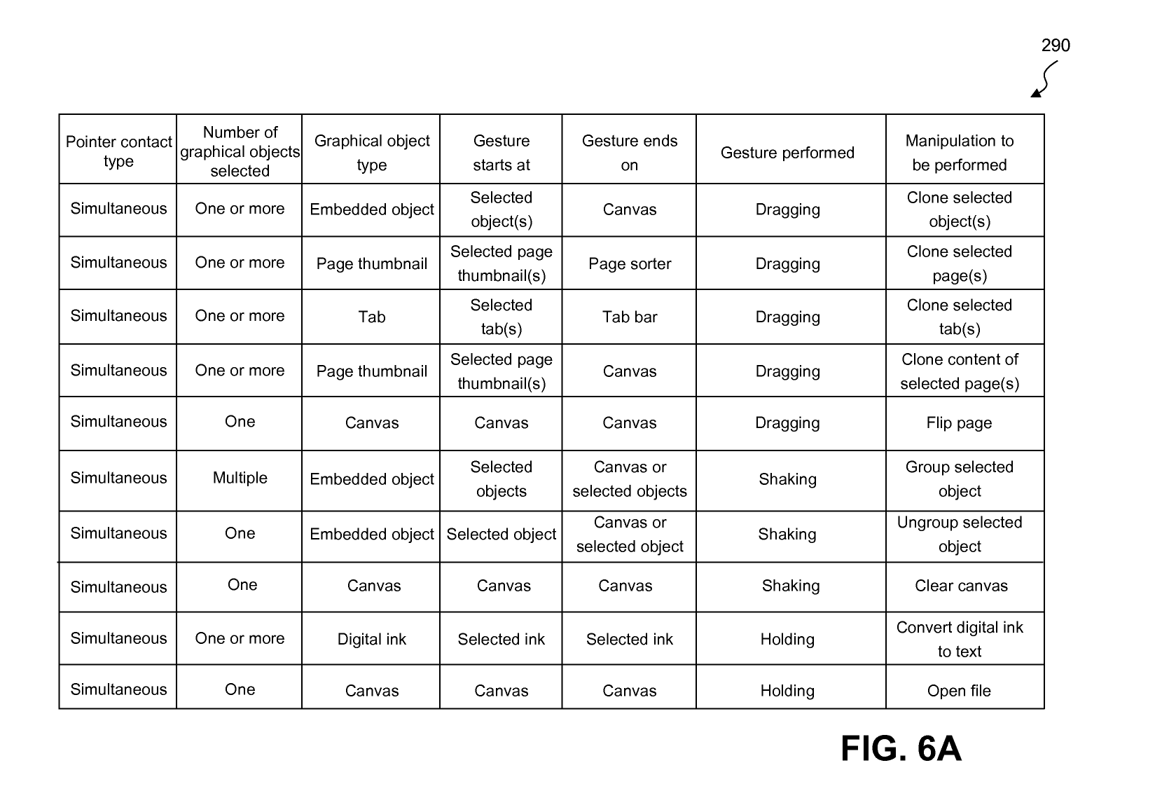

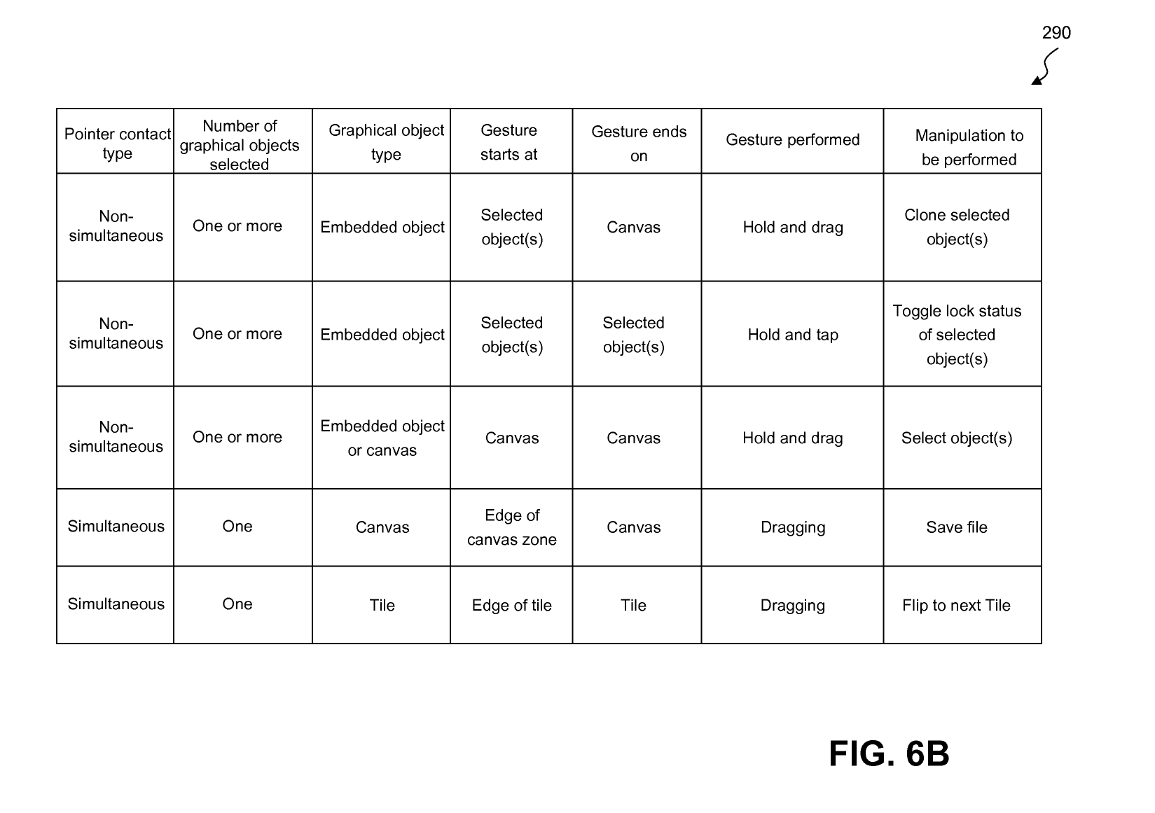

As described above, method 200 uses a predefined lookup table to determine the type of manipulation to be performed based on pointer contact type, the number of graphical objects selected, the graphical object type, the graphical object from which the gesture starts, the graphical object from which the gesture ends, and the gesture performed. In this embodiment the predefined lookup table is configured or customized manually by a user. An exemplary predefined lookup table is shown in FIGS. 6A and 6B and is generally identified by reference numeral 290. Specific examples of manipulation operations shown in predefined lookup table 290 will now be described. During this description, it is assumed that each pointer brought into contact with the interactive surface 24 is operating in the cursor mode.

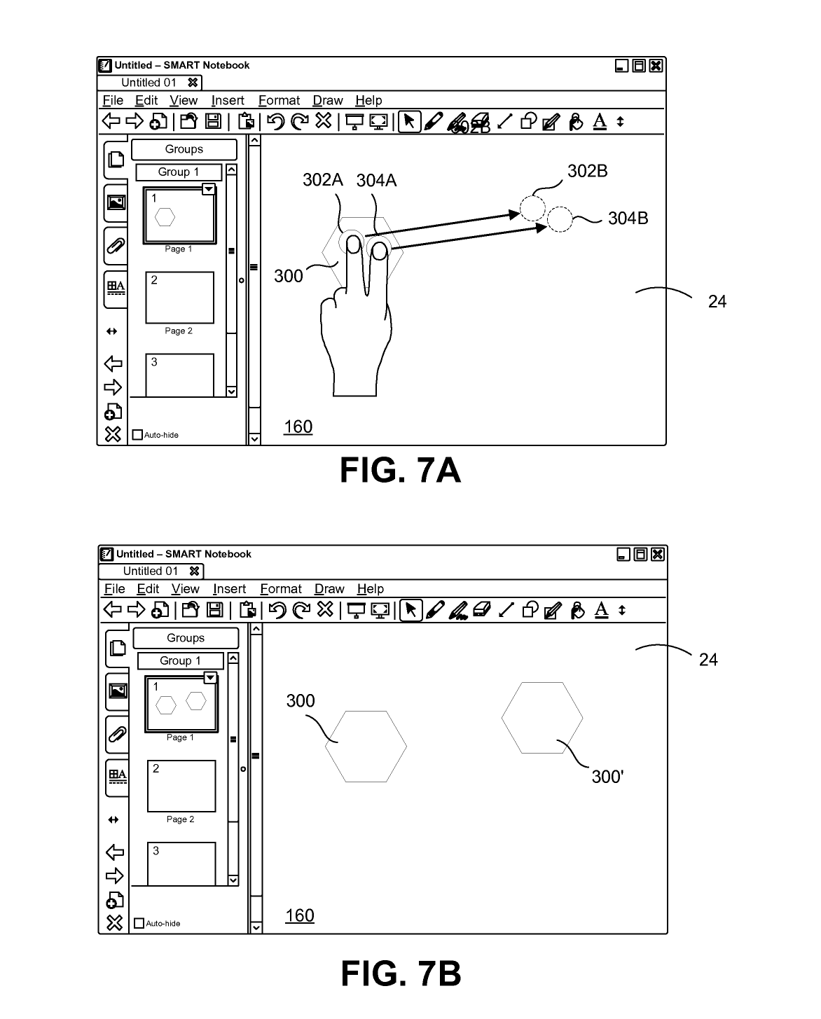

FIGS. 7A and 7B illustrate an example of manipulating an embedded object 300 positioned within the canvas zone 160 of the SMART Notebook™ application window based on the use of two pointers, in this case fingers, simultaneously in contact with the interactive surface 24, according to method 200. As can be seen, two pointer contacts are made on the interactive surface 24 at the location of embedded object 300, identified in FIG. 7A as contact down locations 302A and 304A (step 202). The pointer contact type is determined to be simultaneous according to method 230 (step 206), and the number of graphical objects selected on the interactive surface 24 is determined to be one (1) (step 210). Since the pointer contact type is simultaneous (step 212), the movement of each pointer contact is tracked on the interactive surface 24, as illustrated by the movement from contact down locations 302A and 304A (on the embedded object 300) to contact up locations 302B and 304B (on the canvas zone 160), respectively, and the performed gesture is identified as a dragging gesture according to method 240 (step 214). The pointer contact type (simultaneous), the number of graphical objects selected (one) and the graphical object type (embedded object) are associated with the graphical object from which the gesture starts (the selected embedded object 300), the graphical object from which the gesture ends (the canvas zone 160), and the gesture performed (dragging), and using the lookup table 290, it is determined that the manipulation to be performed is to clone the selected object (step 218). In this example, it is assumed that the manipulation can be applied to embedded object 300 (step 220). As a result, the manipulation is then performed on the embedded object 300 (step 222), wherein the embedded object 300 is cloned as embedded object 300′. The cloned embedded object 300′ is positioned on the canvas zone 160 at contact up locations 302B and 304B, as shown in FIG. 7B.

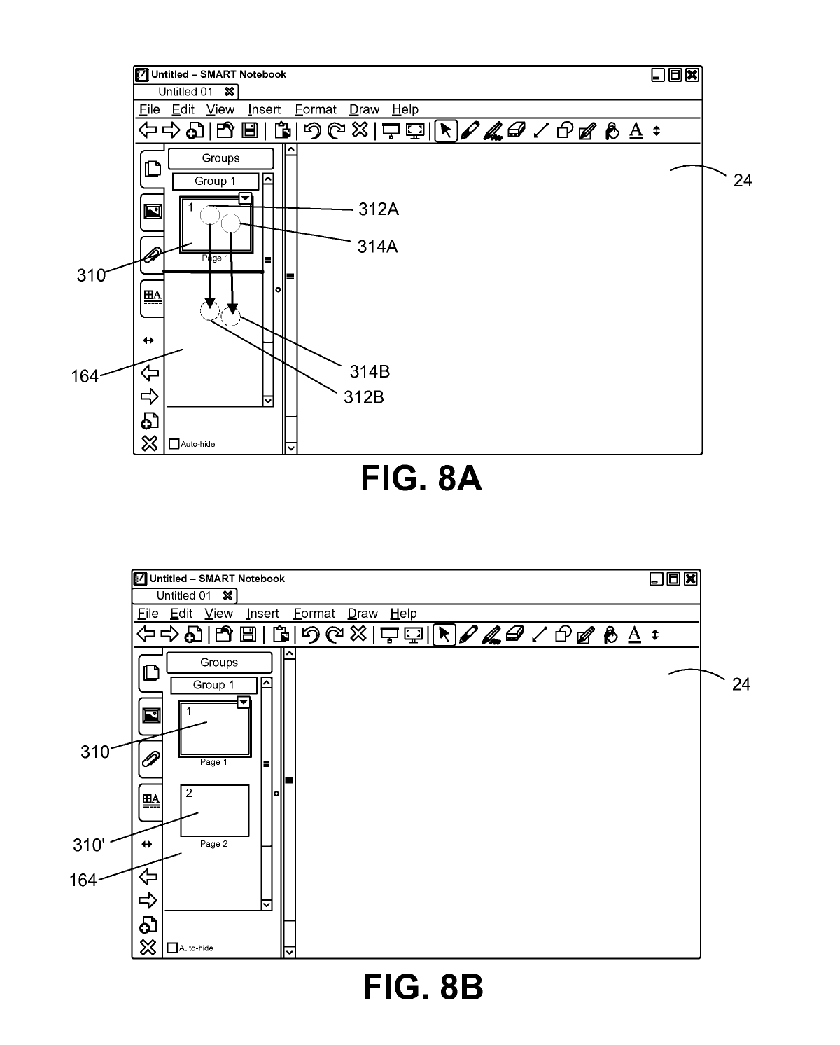

FIGS. 8A and 8B illustrate an example of manipulating a page thumbnail 310 positioned within the page sorter 164 of the SMART Notebook™ application window based on the use of two pointers, in this case fingers, simultaneously in contact with the interactive surface 24, according to method 200. As can be seen, two pointer contacts are made on the interactive surface 24 at the location of page thumbnail 310, identified in FIG. 8A as contact down locations 312A and 314A (step 202). The pointer contact type is determined to be simultaneous according to method 230 (step 206), and the number of graphical objects selected on the interactive surface 24 is determined to be one (1) (step 210). Since the pointer contact type is simultaneous (step 212), the movement of each pointer contact is tracked on the interactive surface 24, as illustrated by the movement from contact down locations 312A and 314A (page thumbnail 310) to contact up locations 312B and 314B (in page sorter 164), respectively, and the performed gesture is identified as a dragging gesture according to method 240 (step 214). The pointer contact type (simultaneous), the number of graphical objects selected (one) and the graphical object type (page thumbnail) are associated with the graphical object from which the gesture starts (the selected page thumbnail 310), the graphical object from which the gesture ends (page sorter 164), and the gesture performed (dragging), and using the lookup table 290, it is determined that the manipulation to be performed is to clone the page associated with the selected page thumbnail 310 (step 218). In this example, it is assumed that the manipulation can be applied to page thumbnail 310 (step 220). As a result, the manipulation is then performed on the page thumbnail 310 (step 222), wherein the page associated with page thumbnail 310 is cloned and displayed as cloned page thumbnail 310′. The cloned page thumbnail 310′ is positioned in the page sorter 164 at contact up locations 312B and 314B, as shown in FIG. 8B.

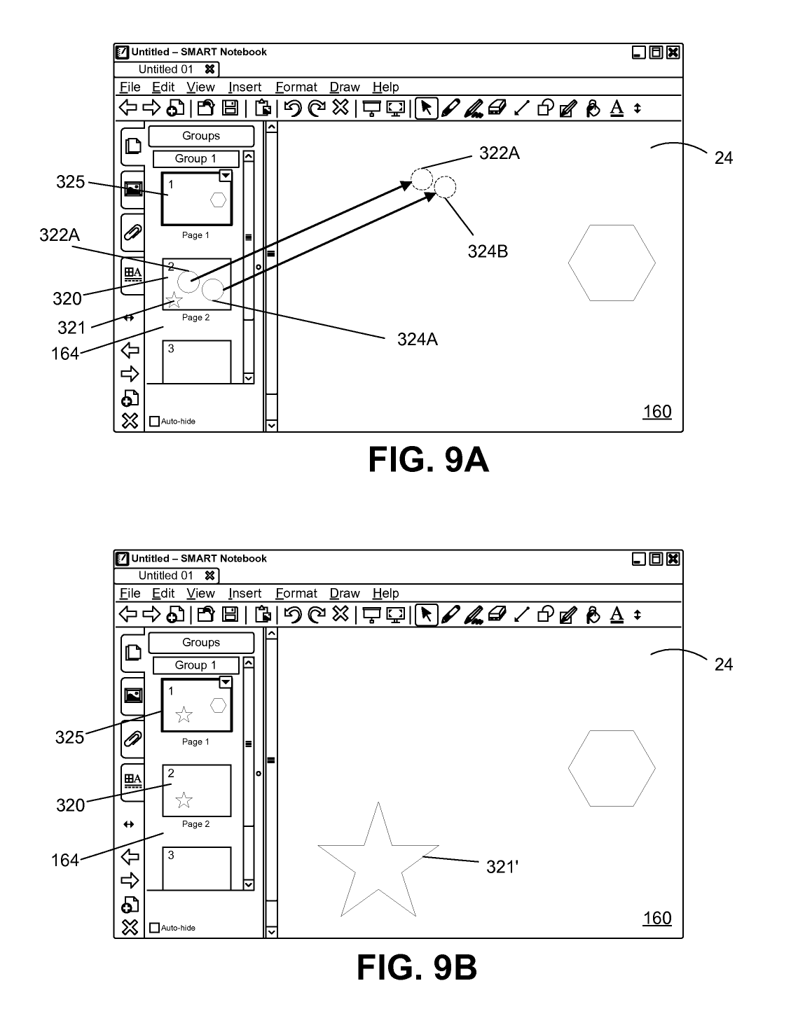

FIGS. 9A and 9B illustrate another example of manipulating a page thumbnail 320 positioned within the page sorter 164 of the SMART Notebook™ application window based on the use of two pointers, in this case fingers, simultaneously in contact with the interactive surface 24, according to method 200. In this example, the page associated with page thumbnail 320 comprises a star-shaped object 321. As can be seen, two pointer contacts are made on the interactive surface 24 at the location of page thumbnail 320, identified in FIG. 9A as contact down locations 322A and 324A (step 202). The pointer contact type is determined to be simultaneous according to method 230 (step 206), and the number of graphical objects selected on the interactive surface 24 is determined to be one (1) (step 210). Since the pointer contact type is simultaneous (step 212), the movement of each pointer contact is tracked on the interactive surface 24, as illustrated by the movement from contact down locations 322A and 324A (page thumbnail 310) to contact up locations 322B and 324B (on the canvas zone 160), respectively, and the performed gesture is identified as a dragging gesture according to method 240 (step 214). The pointer contact type (simultaneous), the number of graphical objects selected (one) and the graphical object type (page thumbnail) are associated with the graphical object from which the gesture starts (the selected page thumbnail 320), the graphical object from which the gesture ends (canvas zone 160), and the gesture performed (dragging), and using the lookup table 290, it is determined that the manipulation to be performed is to clone the contents of the page associated with the selected page thumbnail 320 (step 218). In this example, it is assumed that the manipulation can be applied to page thumbnail 320 (step 220). As a result, the manipulation is then performed on the page thumbnail 320 (step 222), wherein the contents of the page associated with page thumbnail 320, in particular the star-shaped object 321, are cloned and displayed on the canvas zone 160. The cloned star-shaped object 321′ is positioned on the canvas zone 160 at a location on the canvas zone 160 corresponding to the location of the original star-shaped object 321 on the page associated with page thumbnail 320, as shown in FIG. 9B. It will be appreciated that the cloned star-shaped object 321′ is also shown on page thumbnail 325, which is associated with the page displayed on canvas zone 160 in FIG. 9B.

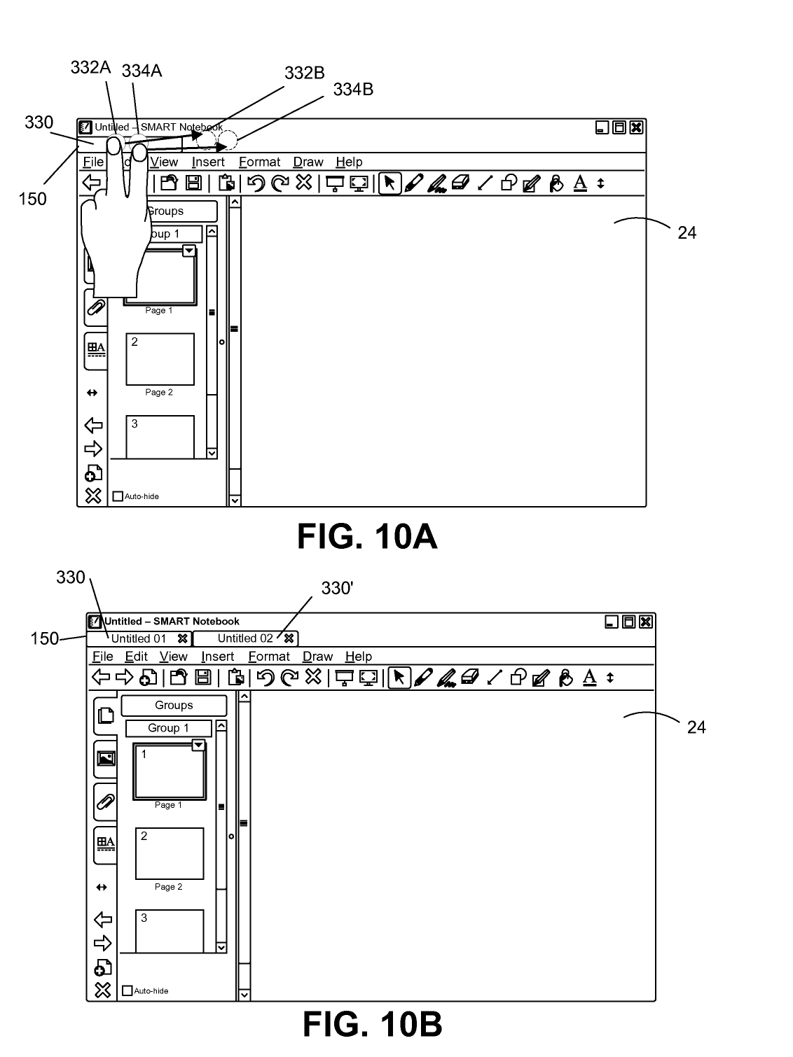

FIGS. 10A and 10B illustrate an example of manipulating a tab 330 positioned within the tab bar 150 of the SMART Notebook™ application window based on the use of two pointers, in this case fingers, simultaneously in contact with the interactive surface 24, according to method 200. As can be seen, two pointer contacts are made on the interactive surface 24 at the location of tab 330, identified in FIG. 10A as contact down locations 332A and 334A (step 202). The pointer contact type is determined to be simultaneous according to method 230 (step 206), and the number of graphical objects selected on the interactive surface 24 is determined to be one (1) (step 210). Since the pointer contact type is simultaneous (step 212), the movement of each pointer contact is tracked on the interactive surface 24, as illustrated by the movement from contact down locations 332A and 334A (tab 330) to contact up locations 332B and 334B (tab bar 150), respectively, and the performed gesture is identified as a dragging gesture according to method 240 (step 214). The pointer contact type (simultaneous), the number of graphical objects selected (one) and the graphical object type (tab) are associated with the graphical object from which the gesture starts (the selected tab 330), the graphical object from which the gesture ends (tab bar 150), and the gesture performed (dragging), and using the lookup table 290, it is determined that the manipulation to be performed is to clone the document associated with tab 330 (step 218). In this example, it is assumed that the manipulation can be applied to tab 330 (step 220). As a result, the manipulation is then performed on the tab 330 (step 222), wherein document associated with tab 330 is cloned and displayed as cloned tab 330′. The cloned tab 330′ is positioned in the tab bar 150 at contact up locations 332B and 334B, as shown in FIG. 10B.

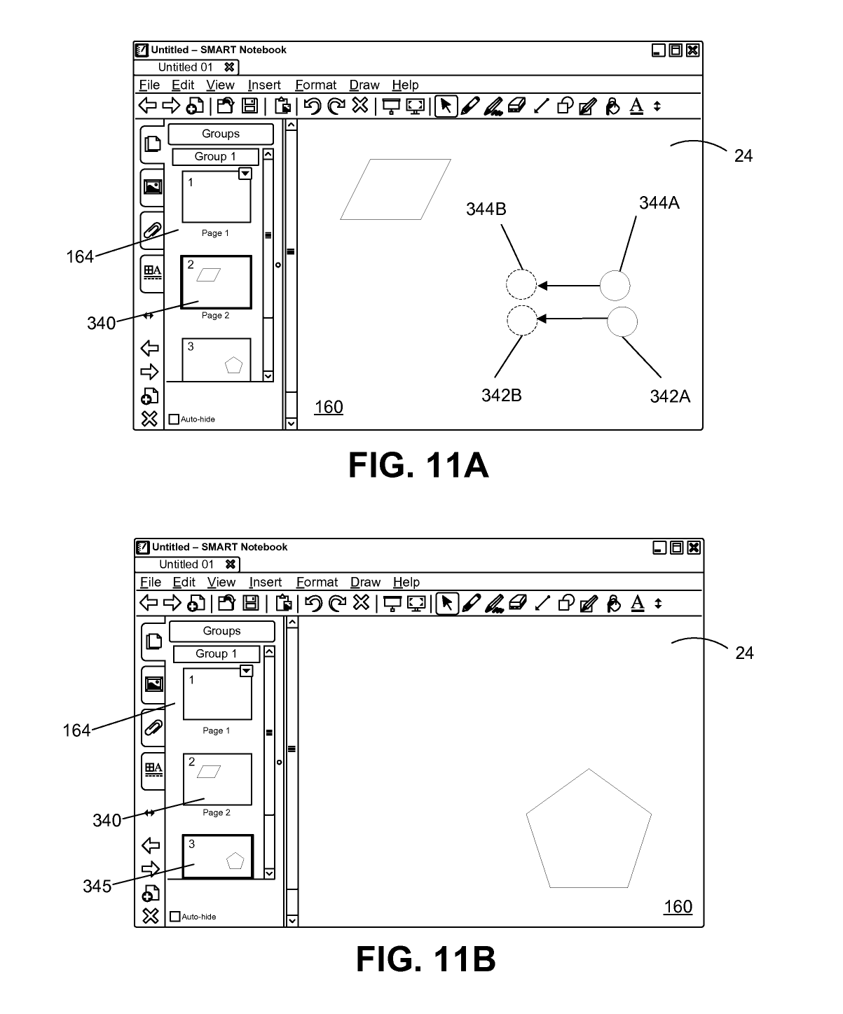

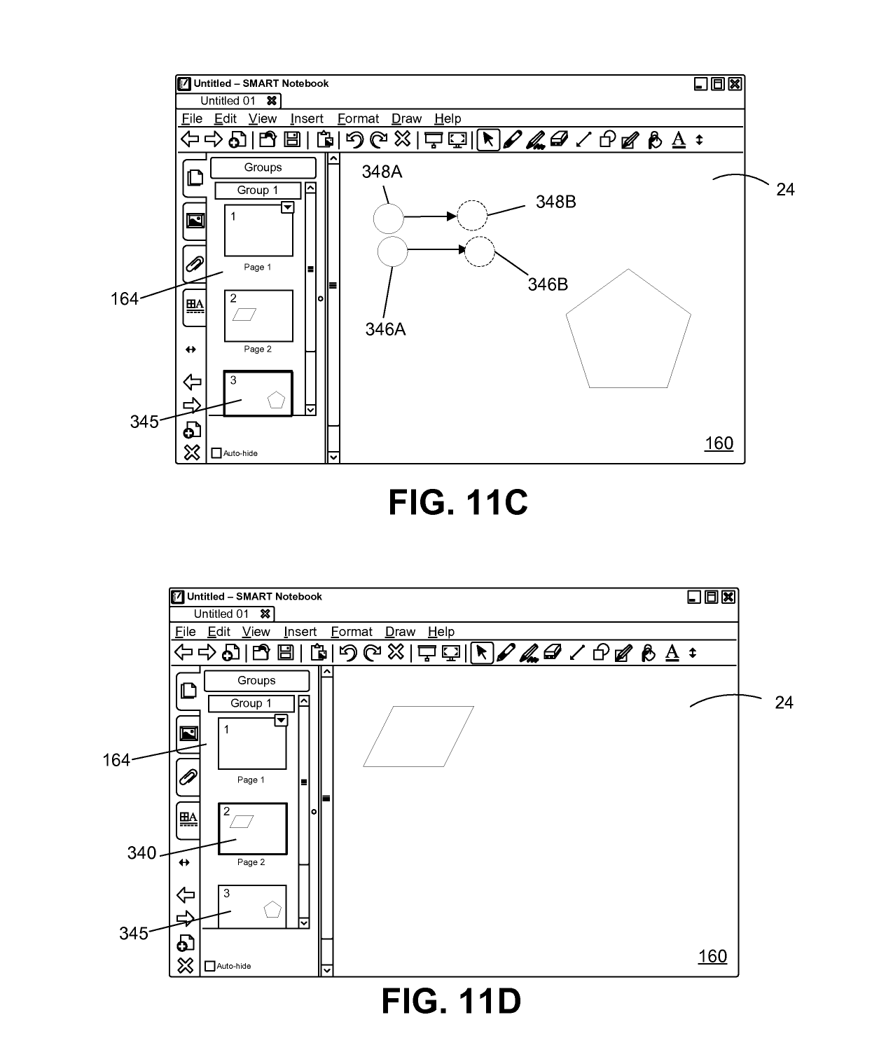

FIGS. 11A and 11B illustrate an example of switching the current page to the next page of the SMART Notebook™ application window based on the use of two pointers, in this case fingers, simultaneously in contact with the interactive surface 24, according to method 200. As can be seen, the page associated with page tab 340 is displayed on the canvas zone 160. Two pointer contacts are made on the interactive surface 24 within the canvas zone 160, identified in FIG. 11A as contact down locations 342A and 344A (step 202). The pointer contact type is determined to be simultaneous according to method 230 (step 206), and the number of graphical objects selected on the interactive surface 24 is determined to be one (1) (step 210). Since the pointer contact type is simultaneous (step 212), the movement of each pointer contact is tracked on the interactive surface 24, as illustrated by the movement from contact down locations 342A and 344A (within canvas zone 160) to contact up locations 342B and 344B (within canvas zone 160), respectively, and the performed gesture is identified as a dragging gesture according to method 240 (step 214). The pointer contact type (simultaneous), the number of graphical objects selected (one) and the graphical object type (canvas) are associated with the graphical object from which the gesture starts (canvas zone 160), the graphical object from which the gesture ends (canvas zone 160), and the gesture performed (dragging to the left), and using the lookup table 290, it is determined that the manipulation to be performed is to switch the current page to the next page (step 218). In this example, it is assumed that the manipulation can be applied to canvas zone 160 (step 220). As a result, the manipulation is then performed on the canvas zone 160 (step 222), wherein the page associated with page tab 345 becomes the current page displayed on the canvas zone 160, as shown in FIG. 11B.

FIGS. 11C and 11D illustrate an example of switching the current page to the previous page of the SMART Notebook™ application window based on the use of two pointers, in this case fingers, simultaneously in contact with the interactive surface 24, according to method 200. As can be seen, the page associated with page tab 345 is displayed on the canvas zone 160. Two pointer contacts are made on the interactive surface 24 within the canvas zone 160, identified in FIG. 11C as contact down locations 346A and 348A (step 202). The pointer contact type is determined to be simultaneous according to method 230 (step 206), and the number of graphical objects selected on the interactive surface 24 is determined to be one (1) (step 210). Since the pointer contact type is simultaneous (step 212), the movement of each pointer contact is tracked on the interactive surface 24, as illustrated by the movement from contact down locations 346A and 348A (within canvas zone 160) to contact up locations 346B and 348B (within canvas zone 160), respectively, and the performed gesture is identified as a dragging gesture according to method 240 (step 214). The pointer contact type (simultaneous), the number of graphical objects selected (one) and the graphical object type (canvas) are associated with the graphical object from which the gesture starts (canvas zone 160), the graphical object from which the gesture ends (canvas zone 160), and the gesture performed (dragging to the right), and using the lookup table 290, it is determined that the manipulation to be performed is to switch the current page to the previous page (step 218). In this example, it is assumed that the manipulation can be applied to canvas zone 160 (step 220). As a result, the manipulation is then performed on the canvas zone 160 (step 222), wherein the page associated with page tab 340 becomes the current page displayed on the canvas zone 160, as shown in FIG. 11D.

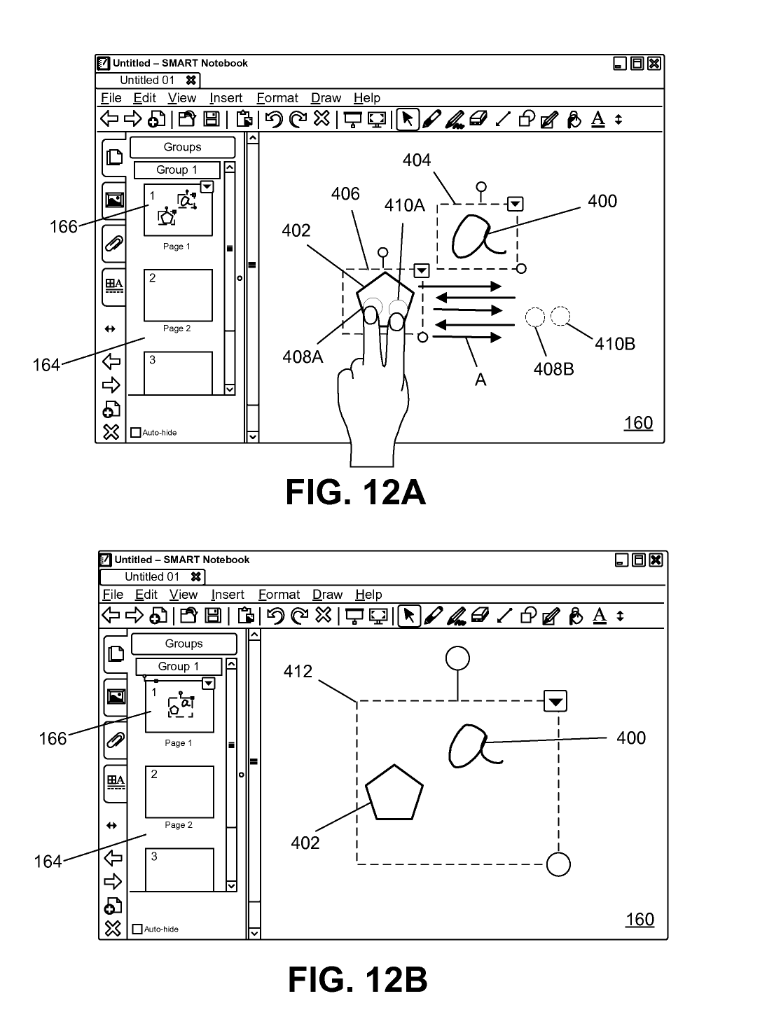

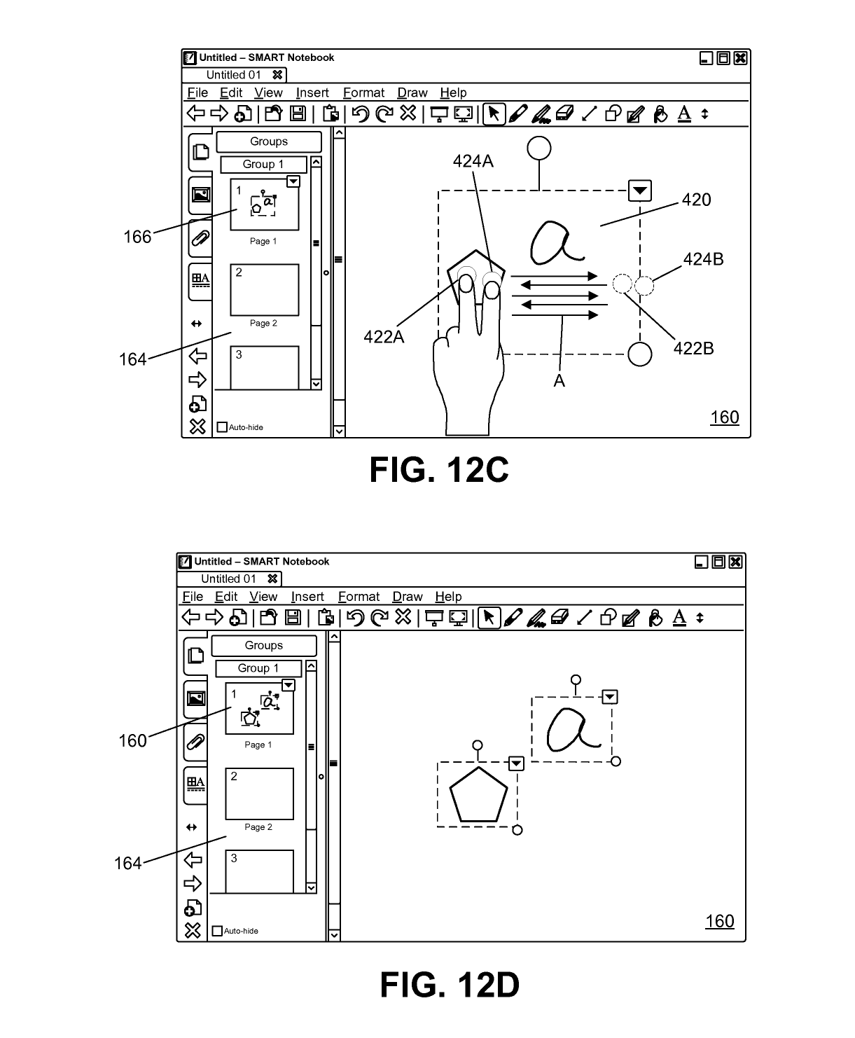

FIGS. 12A and 12B illustrate an example of grouping a selected number of graphical objects positioned within the canvas zone 160 of the SMART Notebook™ application window based on a shaking gesture, according to method 200. As can be seen, two embedded objects 400 and 402 are selected on the canvas zone 160. As will be appreciated, once selected, each of the embedded objects 400 and 402 are outlined with a boundary box 404 and 406, respectively. Two pointer contacts are made on the interactive surface 24 at the location of the boundary box 406, identified in FIG. 12A as contact down locations 408A and 410A (step 202). The pointer contact type is determined to be simultaneous according to method 230 (step 206), and the number of graphical objects selected on the interactive surface 24 is determined to be two (2) (step 210). The movement of each pointer contact is tracked on the interactive surface 24, as illustrated by the movement between contact down locations 408A and 410A (at the location of boundary box 406) and contact up locations 408B and 410B (within canvas zone 160), respectively. As can be seen, the movement of each of the pointer contacts changes direction by approximately 180° a total of five (5) times, as indicated by arrows A, and thus the performed gesture is identified as a shaking gesture according to method 240 (step 214). The pointer contact type (simultaneous), the number of graphical objects selected (two) and the graphical object type (embedded objects) are associated with the graphical object from which the gesture starts (selected embedded object 400), the graphical object from which the gesture ends (canvas zone 160), and the gesture performed (shaking), and using the lookup table 290, it is determined that the manipulation to be performed is to group the selected embedded objects 400 and 402 (step 218). In this example, it is assumed that the manipulation can be applied to the embedded objects 400 and 402 (step 220). As a result, the manipulation is performed on the embedded objects 400 and 402 (step 222), wherein the embedded objects 400 and 402 are grouped, indicated by boundary box 410 as shown in FIG. 12B.

FIGS. 12C and 12D illustrate an example of ungrouping a selected graphical object positioned within the canvas zone 160 of the SMART Notebook™ application window based on a shaking gesture, according to method 200. As can be seen, a single embedded object 420 is selected on the canvas zone 160. Two pointer contacts are made on the interactive surface 24 at the location of the embedded object 420, identified in FIG. 12C as contact down locations 422A and 424A (step 202). The pointer contact type is determined to be simultaneous according to method 230 (step 206), and the number of graphical objects selected on the interactive surface 24 is determined to be one (1) (step 210). The movement of each pointer contact is tracked on the interactive surface 24, as illustrated by the movement between contact down locations 422A and 424A (at the location of boundary box 406) and contact up locations 422B and 424B (within canvas zone 160), respectively. As can be seen, the movement of each of the pointer contacts changes direction by approximately 180° a total of five (5) times, as indicated by arrows A, and thus the performed gesture is identified as a shaking gesture according to method 240 (step 214). The pointer contact type (simultaneous), the number of graphical objects selected (one) and the graphical object type (embedded object) are associated with the graphical object from which the gesture starts (selected embedded object 420), the graphical object from which the gesture ends (canvas zone 160), and the gesture performed (shaking), and using the lookup table 290, it is determined that the manipulation to be performed is to ungroup the selected embedded object 420 (step 218). In this example, it is assumed that the manipulation can be applied to the embedded object 420 (step 220). As a result, the manipulation is performed on the embedded object 420 (step 222), wherein the embedded object 420 is ungrouped, as shown in FIG. 12D.

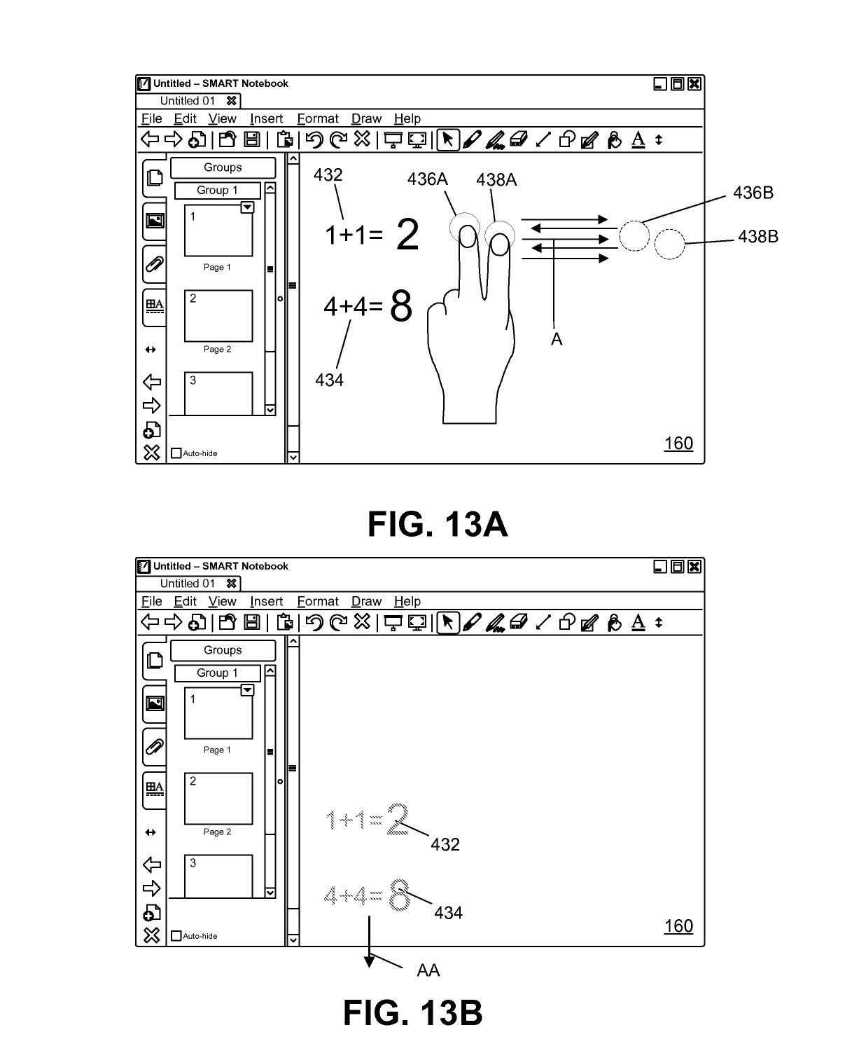

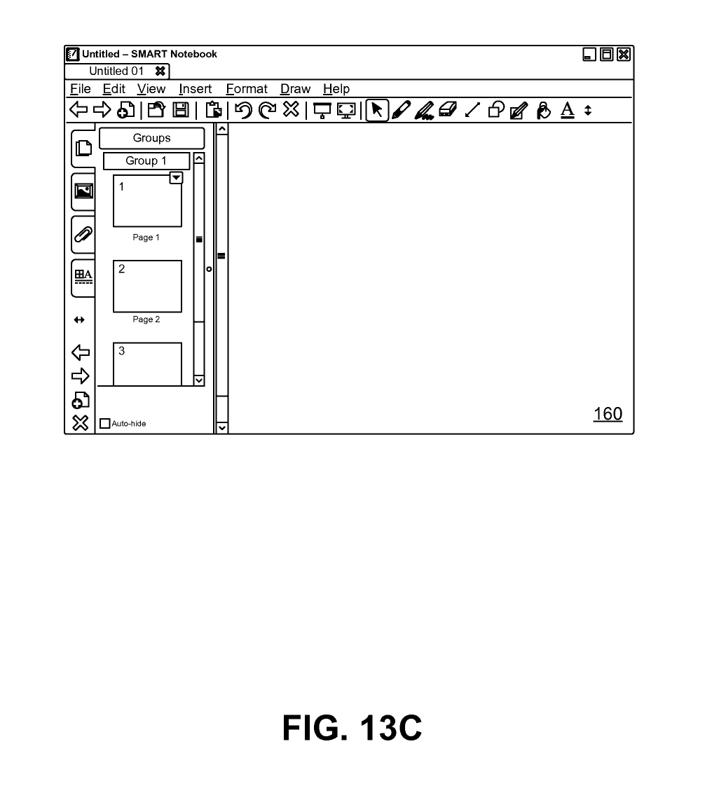

FIGS. 13A to 13C illustrate an example of clearing the content within the canvas zone 160 of the SMART Notebook™ application window based on a shaking gesture, according to method 200. As can be seen, two embedded objects 432 and 434 are positioned on the canvas zone 160. Two pointer contacts are made on the interactive surface 24 within the canvas zone 160, identified in FIG. 13A as contact down locations 436A and 438A (step 202). The pointer contact type is determined to be simultaneous according to method 230 (step 206), and the number of graphical objects selected on the interactive surface 24 is determined to be one (1) (step 210). The movement of each pointer contact is tracked on the interactive surface 24, as illustrated by the movement between contact down locations 436A and 438A (within canvas zone 160) and contact up locations 436B and 438B (within canvas zone 160), respectively. As can be seen, the movement of each of the pointer contacts changes direction by approximately 180° a total of five (5) times, as indicated by arrows A, and thus the performed gesture is identified as a shaking gesture according to method 240 (step 214). The pointer contact type (simultaneous), the number of graphical objects selected (one) and the graphical object type (canvas zone 160) are associated with the graphical object from which the gesture starts (canvas zone 160), the graphical object from which the gesture ends (canvas zone 160), and the gesture performed (shaking), and using the lookup table 290, it is determined that the manipulation to be performed is to clear the content of the canvas zone 160 (step 218). In this example, it is assumed that the manipulation can be applied to the canvas zone 160 (step 220). As a result, the manipulation is performed on the canvas zone 160 (step 222), wherein the embedded objects 432 and 434 are cleared according to a known animation of fading out and falling off the canvas zone 160. As such, the embedded objects 432 and 434 fall off the canvas, indicated by arrow AA in FIG. 13B, and simultaneously fade out, until the canvas zone 160 is cleared as shown in FIG. 13C.

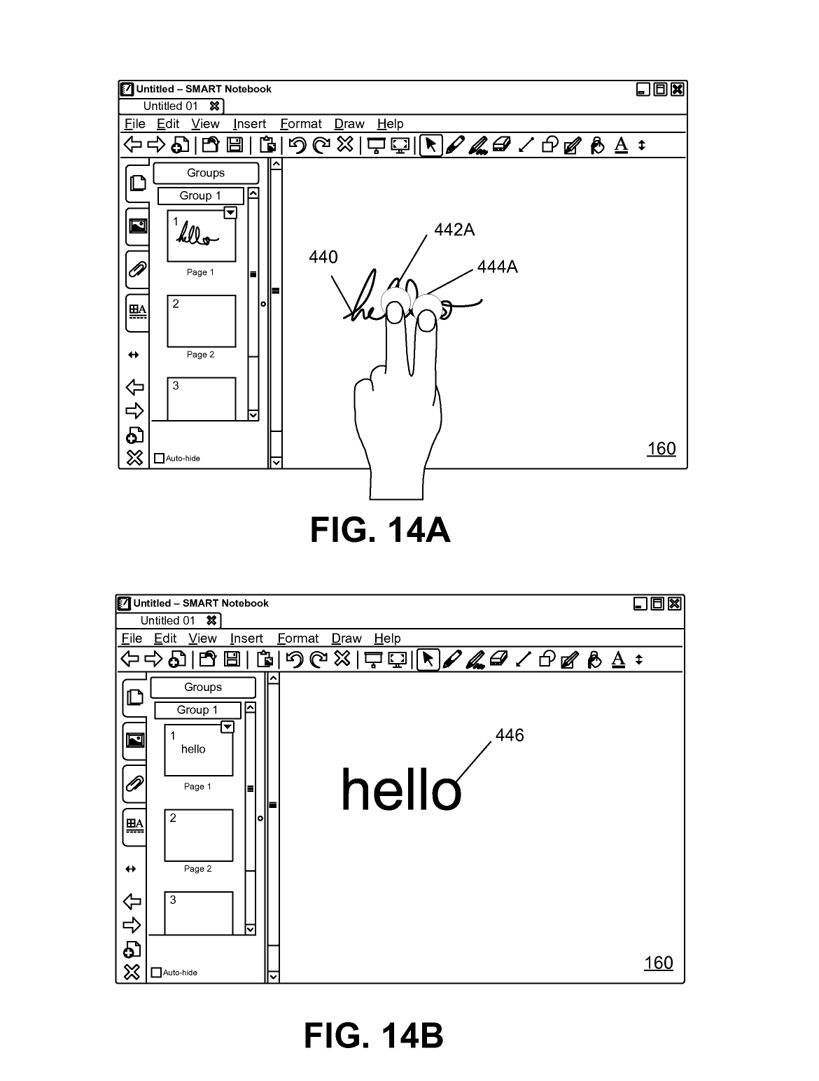

FIGS. 14A and 14B illustrate an example of manipulating digital ink 440 positioned within the canvas zone 160 of the SMART Notebook™ application window based on the use of two pointers, in this case fingers, simultaneously in contact with the interactive surface 24, according to method 200. As can be seen, two pointer contacts are made on the interactive surface 24 at the location of digital ink 440, identified in FIG. 14A as contact down locations 442A and 444A (step 202). The pointer contact type is determined to be simultaneous according to method 230 (step 206), and the number of graphical objects selected on the interactive surface 24 is determined to be one (1) (step 210). As can be seen, each pointer contact remains at contact down locations 442A and 444A, respectively, and thus the performed gesture is identified as a holding gesture according to method 240 (step 214). The pointer contact type (simultaneous), the number of graphical objects selected (one) and the graphical object type (digital ink 440) are associated with the graphical object from which the gesture starts (digital ink 440), the graphical object from which the gesture ends (digital ink 440), and the gesture performed (holding gesture), and using the lookup table 290, it is determined that the manipulation to be performed is to convert the digital ink 440 to text (step 218). In this example, it is assumed that the manipulation can be applied to the digital ink 440 (step 220). As a result, the manipulation is then performed on the digital ink 440 (step 222), wherein the digital ink 440 is converted to text 446, as shown in FIG. 14B.

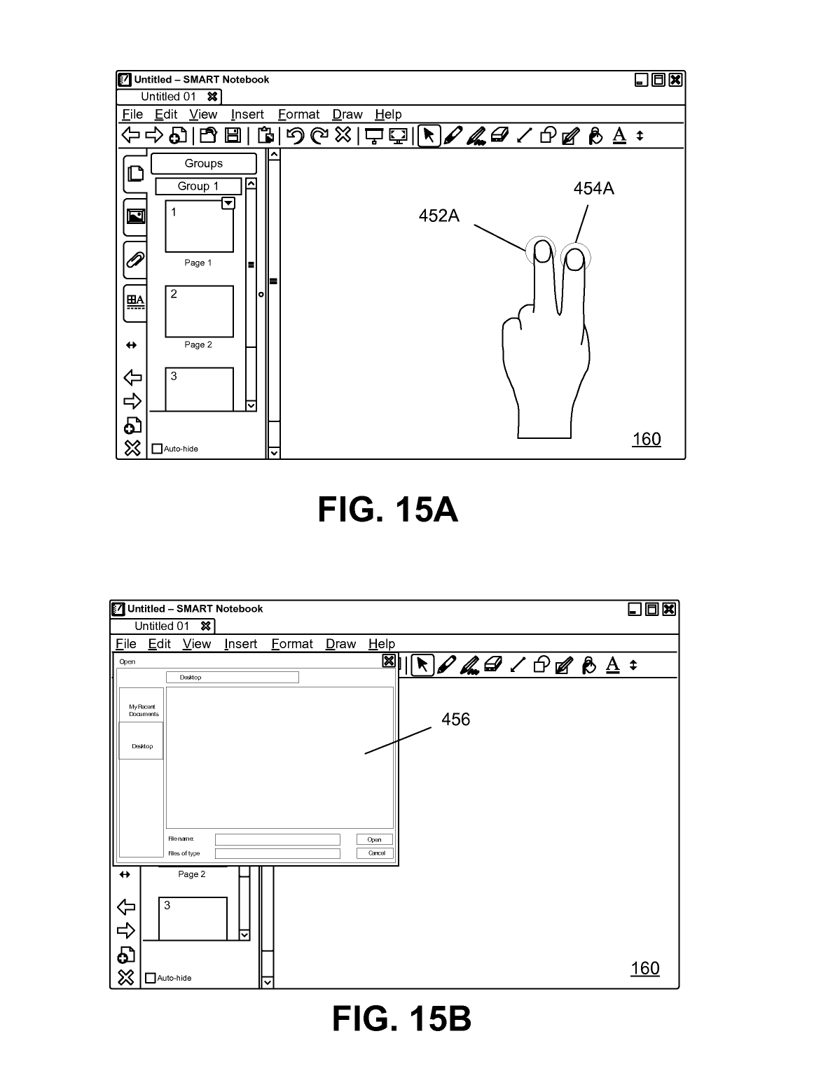

FIGS. 15A and 15B illustrate an example of opening a file associated with the SMART Notebook™ application window based on the use of two pointers, in this case fingers, simultaneously in contact with the interactive surface 24, according to method 200. As can be seen, two poiter contacts are made on the interactive surface 24 at the location of the canvas zone 160, identified in FIG. 15A as contact down locations 452A and 454A (step 202). The pointer contact type is determined to be simultaneous according to method 230 (step 206), and the number of graphical objects selected on the interactive surface 24 is determined to be one (1) (step 210). As can be seen, each pointer contact remains at contact down locations 452A and 454A, respectively, and thus the performed gesture is identified as a holding gesture according to method 240 (step 214). The pointer contact type (simultaneous), the number of graphical objects selected (one) and the graphical object type (canvas zone 160) are associated with the graphical object from which the gesture starts (canvas zone 160), the graphical object from which the gesture ends (canvas zone 160), and the gesture performed (holding gesture), and using the lookup table 290, it is determined that the manipulation to be performed is to open a file (step 218). In this example, it is assumed that the manipulation can be applied to the canvas zone 160 (step 220). As a result, the manipulation is then performed (step 222), wherein an open file dialog box 456 appears prompting a user to choose a file, as shown in FIG. 15B.

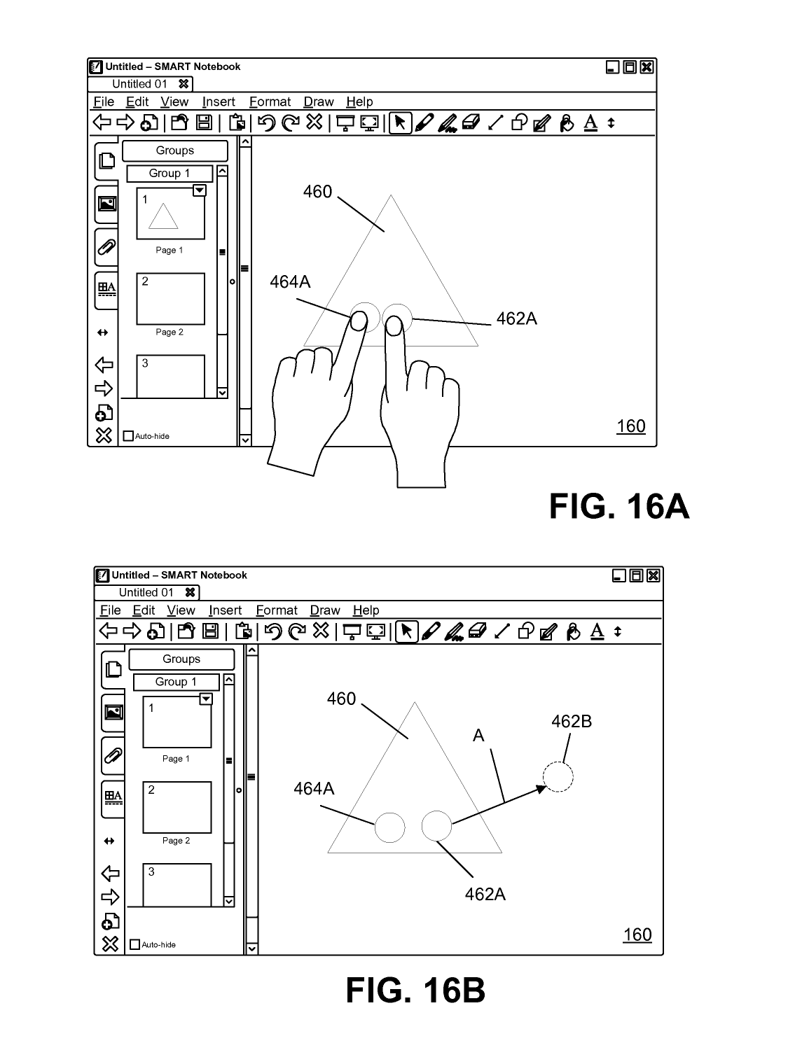

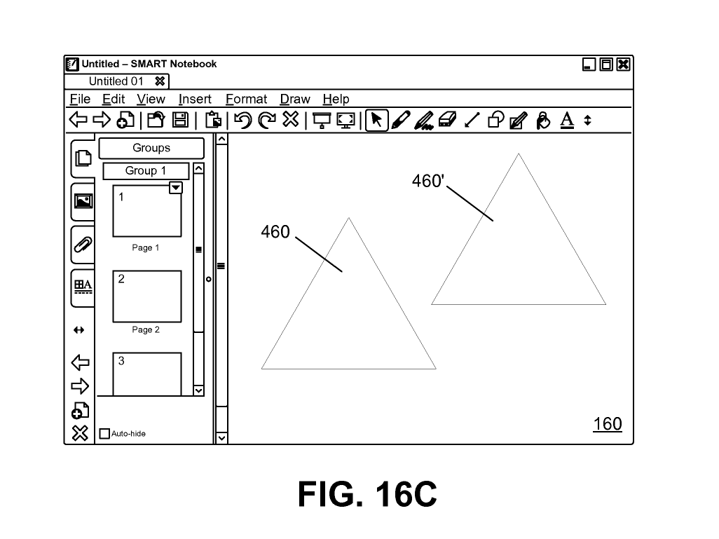

FIGS. 16A to 16C illustrate another example of manipulating an embedded object 460 positioned within the canvas zone 160 of the SMART Notebook™ application window based on the use of two pointers, in this case fingers, non-simultaneously in contact with the interactive surface 24, according to method 200. As can be seen, two pointer contacts are made on the interactive surface 24 at the location of embedded object 460, identified in FIG. 16A as contact down locations 462A and 464A (step 202). The pointer contact type is determined to be non-simultaneous according to method 230 (step 206), and the number of graphical objects selected on the interactive surface 24 is determined to be one (1) (step 210). The movement of each pointer contact is tracked on the interactive surface 24, as shown in FIG. 16B. As can be seen, a first pointer contact moves from contact down location 462A (on the embedded object 460) to contact up location 462B (on the canvas zone 160) indicated by arrow A. The second pointer contact remains at contact down location 464A (on the embedded object 460), and thus the performed gesture is identified as a hold and drag gesture according to method 270 (step 216). The pointer contact type (non-simultaneous), the number of graphical objects selected (one) and the graphical object type (embedded object) are associated with the graphical object from which the gesture starts (the selected embedded object 460), the graphical object from which the gesture ends (the selected embedded object 460 and the canvas zone 160), and the gesture performed (hold and drag), and using the lookup table 290, it is determined that the manipulation to be performed is to clone the selected graphical object (step 218). In this example, it is assumed that the manipulation can be applied to embedded object 460 (step 220). As a result, the manipulation is then performed on the embedded object 460 (step 222), wherein the embedded object 460 is cloned as embedded object 460′. The cloned embedded object 460′ is positioned on the canvas zone 160 at contact up location 462B, as shown in FIG. 16C.

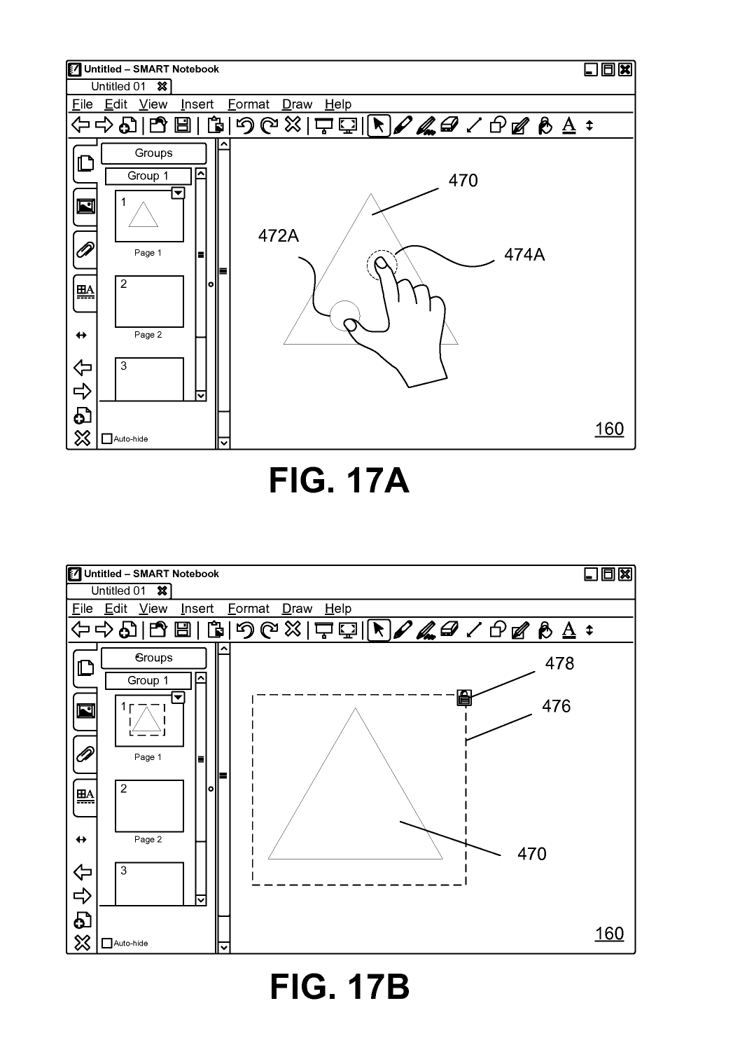

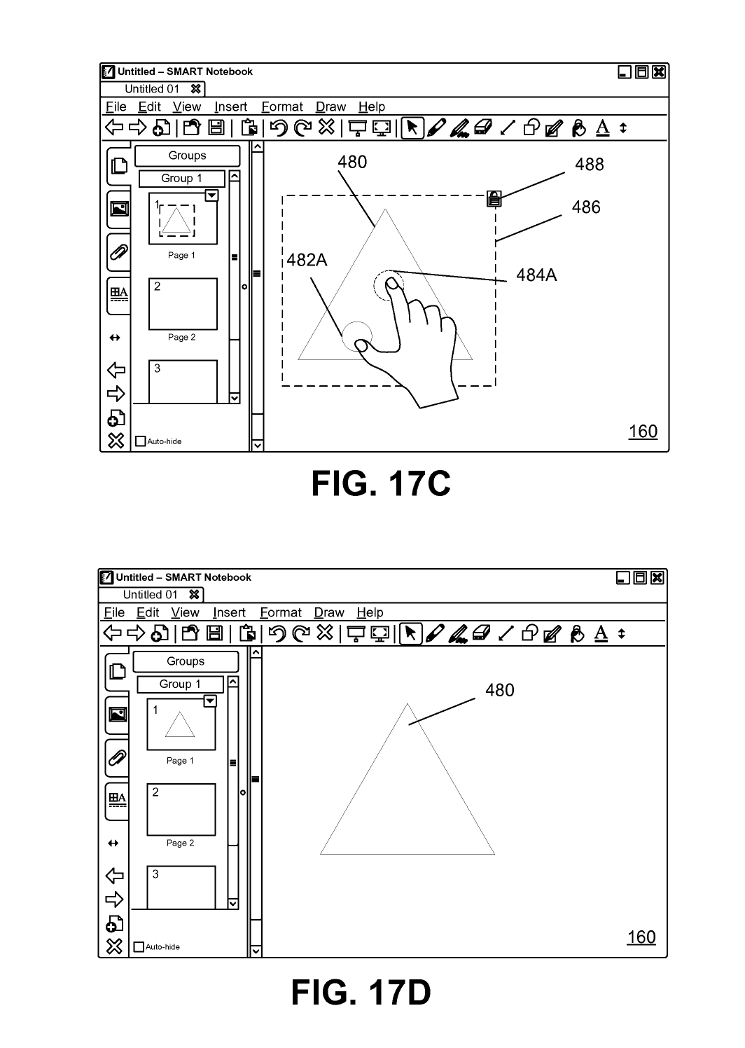

FIGS. 17A and 17B illustrate an example of locking an embedded object 470 positioned within the canvas zone 160 of the SMART Notebook™ application window based on the use of two pointers, in this case fingers, non-simultaneously in contact with the interactive surface 24, according to method 200. As can be seen, two pointer contacts are made on the interactive surface 24 at the location of embedded object 470, identified in FIG. 17A as contact down locations 472A and 474A (step 202). The pointer contact type is determined to be non-simultaneous according to method 230 (step 206), and the number of graphical objects selected on the interactive surface 24 is determined to be one (1) (step 210). The movement of each pointer contact is tracked on the interactive surface 24. A first pointer contact remains at contact down location 472A (on the embedded object 470). A second pointer contact taps on the embedded object 470 at contact down location 474A, and thus the performed gesture is identified as a hold and tap gesture according to method 270 (step 216). The pointer contact type (non-simultaneous), the number of graphical objects selected (one) and the graphical object type (embedded object) are associated with the graphical object from which the gesture starts (the selected embedded object 470), the graphical object from which the gesture ends (the selected embedded object 470), and the gesture performed (hold and tap), and using the lookup table 290, it is determined that the manipulation to be performed is to lock/unlock the selected embedded object (step 218). In this example, it is assumed that the manipulation can be applied to embedded object 470 (step 220). As a result, the manipulation is performed on the embedded object 470 (step 222), and since embedded object 470 is unlocked, the embedded object 470 becomes locked as shown in FIG. 17B, wherein a boundary box 476 is positioned around the embedded object 470. As can be seen, boundary box 476 comprises a locked icon 478, indicating to the user that the embedded object 470 is locked.

FIGS. 17C and 17D illustrate an example of unlocking an embedded object 480 positioned within the canvas zone 160 of the SMART Notebook™ application window based on the use of two pointers, in this case fingers, non-simultaneously in contact with the interactive surface 24, according to method 200. A boundary box 486 is positioned around the embedded object 480. The boundary box 486 comprises a locked icon 488, indicating to the user that the embedded object 480 is locked. As can be seen, two pointer contacts are made on the interactive surface 24 at the location of embedded object 480, identified in FIG. 17C as contact down locations 482A and 484A (step 202). The pointer contact type is determined to be non-simultaneous according to method 230 (step 206), and the number of graphical objects selected on the interactive surface 24 is determined to be one (1) (step 210). The movement of each pointer contact is tracked on the interactive surface 24. A first pointe contact remains at contact down location 482A (on the embedded object 470). A second pointer contact taps on the embedded object 480 at contact down location 484A, and thus the performed gesture is identified as a hold and tap gesture according to method 270 (step 216). The pointer contact type (non-simultaneous), the number of graphical objects selected (one) and the graphical object type (embedded object) are associated with the graphical object from which the gesture starts (the selected embedded object 480), the graphical object from which the gesture ends (the selected embedded object 480), and the gesture performed (hold and tap), and using the lookup table 290, it is determined that the manipulation to be performed is to lock/unlock the selected embedded object (step 218). In this example, it is assumed that the manipulation can be applied to embedded object 480 (step 220). As a result, the manipulation is performed on the embedded object 480 (step 222), and since embedded object 480 is locked, the embedded object 480 becomes unlocked as shown in FIG. 17D.

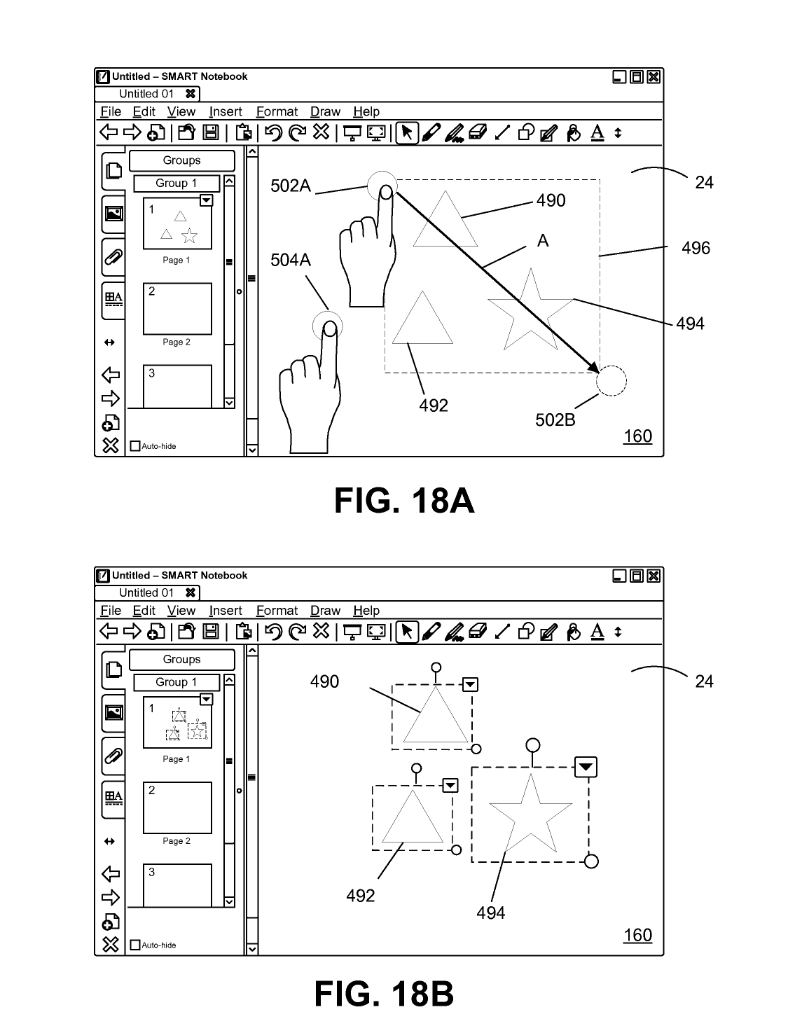

FIGS. 18A and 18B illustrate an example of selecting embedded objects 490, 492 and 494 positioned within the canvas zone 160 of the SMART Notebook™ application window based on the use of two pointers, in this case fingers, non-simultaneously in contact with the interactive surface 24, according to method 200. As can be seen, two pointer contacts are made on the interactive surface 24 within the canvas zone 160, identified in FIG. 18A as contact down locations 502A and 504A (step 202). The pointer contact type is determined to be non-simultaneous according to method 230 (step 206), and the number of graphical objects selected on the interactive surface 24 is determined to be one (1) (step 210). The movement of each pointer contact is tracked on the interactive surface 24, as shown in FIG. 18A. As can be seen, a first pointer contact moves from contact down location 502A (within the canvas zone 160) to contact up location 502B (within the canvas zone 160) indicated by arrow A, thereby creating a selection box 496. The second pointer contact remains at contact down location 504A (within the canvas zone 160), and thus the performed gesture is identified as a hold and drag gesture according to method 270 (step 216). The pointer contact type (non-simultaneous), the number of graphical objects selected (one) and the graphical object type (canvas zone 160) are associated with the graphical object from which the gesture starts (canvas zone 160), the graphical object from which the gesture ends (canvas zone 160), and the gesture performed (hold and drag), and using the lookup table 290, it is determined that the manipulation to be performed is to select embedded object(s) (step 218). In this example, it is assumed that the manipulation can be applied to canvas zone 160 (step 220). As a result, the manipulation is then performed on the canvas zone 160 (step 222), wherein all objects positioned within selection box 496, that is, embedded objects 490, 492 and 494, are selected as shown in FIG. 18B.

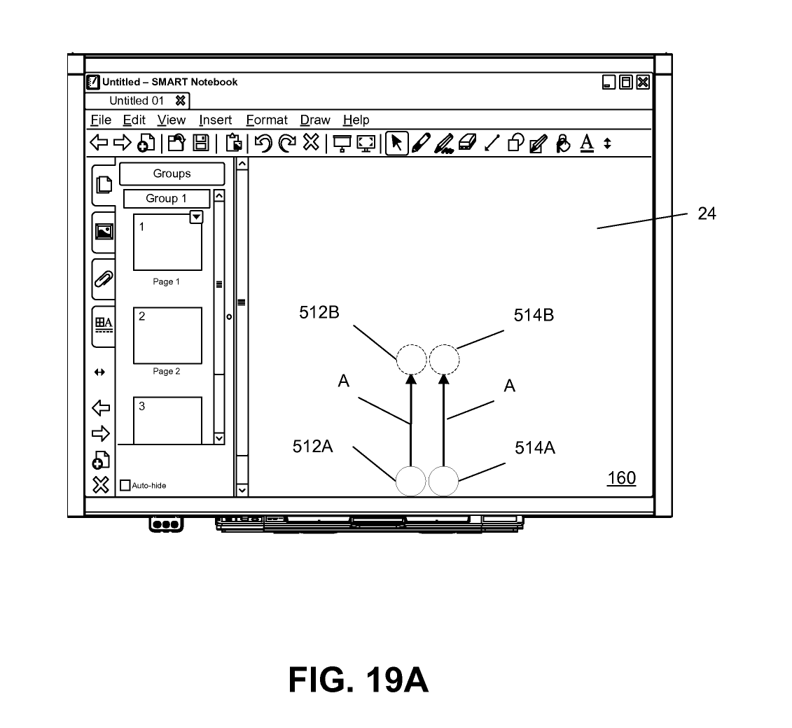

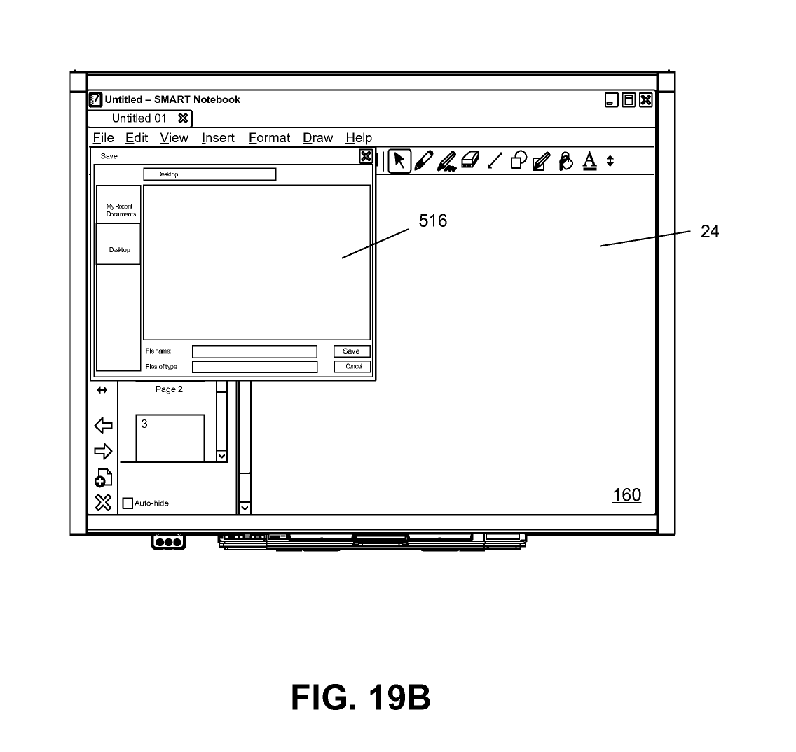

FIGS. 19A and 19B illustrate an example of saving an open file in the SMART Notebook™ application window based on the use of two pointers, in this case fingers, simultaneously in contact with the interactive surface 24, according to method 200. As can be seen, two pointer contacts are made on the interactive surface 24 at the edge of the canvas zone 160, identified in FIG. 19A as contact down locations 512A and 514A (step 202). The pointer contact type is determined to be simultaneous according to method 230 (step 206), and the number of graphical objects selected on the interactive surface 24 is determined to be one (1) (step 210). The movement of each pointer contact is tracked on the interactive surface 24, as illustrated by the movement from contact down locations 512A and 514A (on at the edge of the canvas zone 160) to contact up locations 512B and 514B (on the canvas zone 160), respectively, and the performed gesture is identified as a dragging gesture according to method 240 (step 214). The pointer contact type (simultaneous), the number of graphical objects selected (one) and the graphical object type (canvas zone 160) are associated with the graphical object from which the gesture starts (the edge of the canvas zone 160), the graphical object from which the gesture ends (canvas zone 160), and the gesture performed (dragging gesture), and using the lookup table 290, it is determined that the manipulation to be performed is to save the open file (step 218). In this example, it is assumed that the manipulation can be applied to the canvas zone 160 (step 220). As a result, the manipulation is then performed (step 222), wherein a save file dialog box 516 appears, as shown in FIG. 19B.

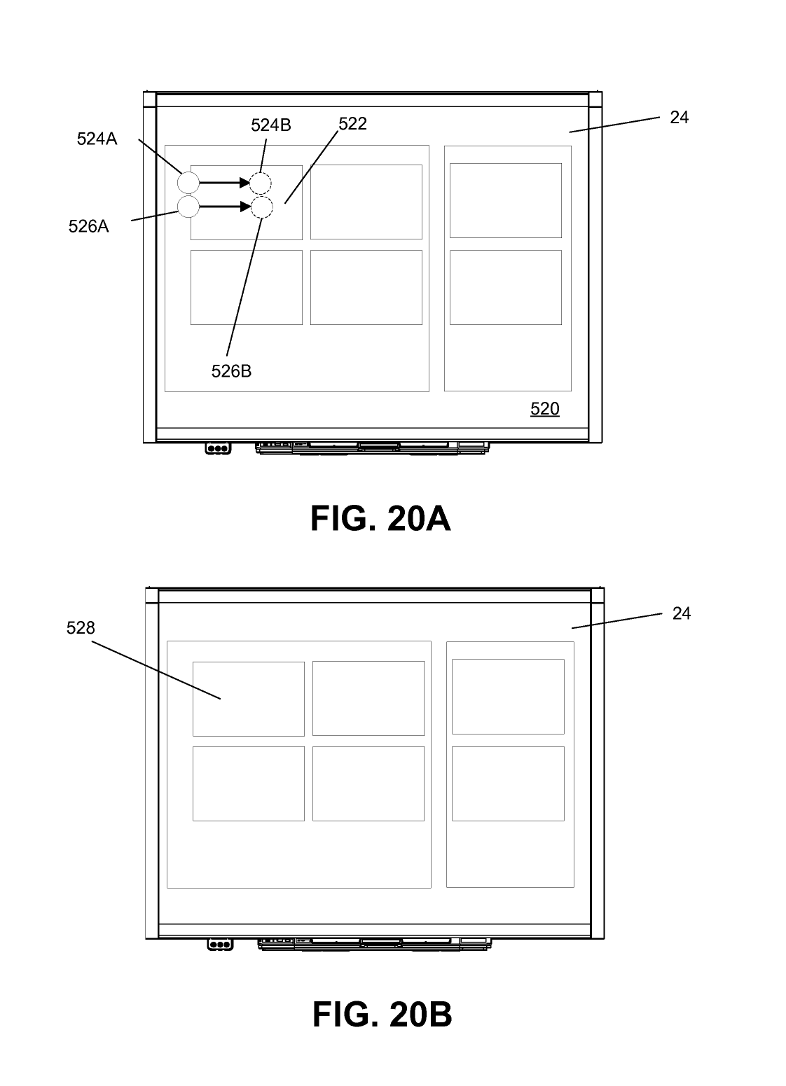

FIGS. 20A and 20B illustrate another example of switching the current page to the next page on a tile page 520 associated with the SMART Notebook™ application window based on the use of two pointers, in this case fingers, simultaneously in contact with the interactive surface 24, according to method 200. As can be seen, two pointer contacts are made on the interactive surface 24 at the edge of tile 522, identified in FIG. 20A as contact down locations 524A and 526A (step 202). The pointer contact type is determined to be simultaneous according to method 230 (step 206), and the number of graphical objects selected on the interactive surface 24 is determined to be one (1) (step 210). The movement of each pointer contact is tracked on the interactive surface 24, as illustrated by the movement from contact down locations 524A and 526A (at the edge of page thumbnail 522) to contact up locations 524B and 526B (at a location within page thumbnail 522), respectively, and the performed gesture is identified as a dragging gesture according to method 240 (step 214). The pointer contact type (simultaneous), the number of graphical objects selected (one) and the graphical object type (tile) are associated with the graphical object from which the gesture starts (the edge of tile 522), the graphical object from which the gesture ends (a location on tile 522), and the gesture performed (dragging gesture), and using the lookup table 290, it is determined that the manipulation to be performed is to flip to next tile (step 218). In this example, it is assumed that the manipulation can be applied to the tile page 520 (step 220). As a result, the manipulation is then performed (step 222), wherein the next page of tile 528 is shown, as shown in FIG. 20B. As will be appreciated, a similar gesture may be used to flip to the previous tile.

As described above, the shaking gesture is defined as a pointer horizontally moving back and forth a set number of times. As will be appreciated, in some alternative embodiments, the pointer movement employed to invoke the shaking gesture may be in any direction, and/or for a different number of times. In some other embodiments, the shaking gesture may be identified as an object-grouping gesture if none of the selected graphical object(s) is a grouped object, and as an object-ungrouping gesture if one or more selected graphical objects are grouped objects.

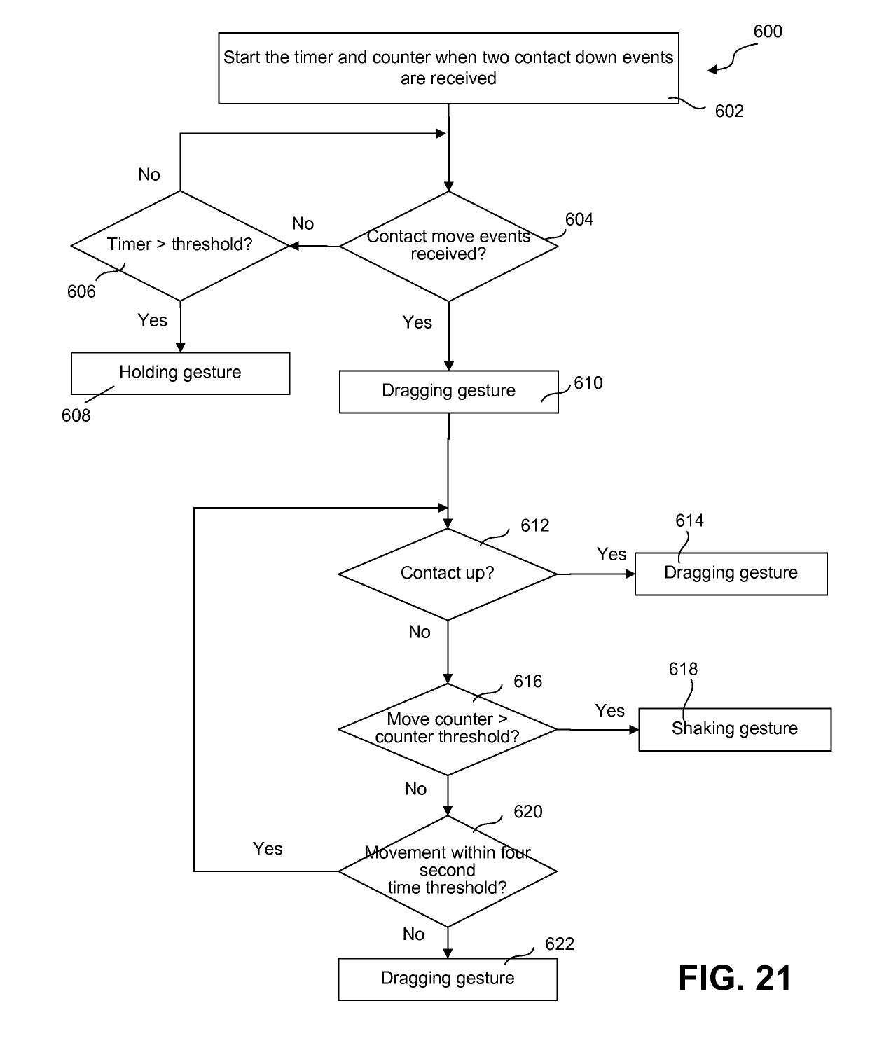

In another embodiment, simultaneous gestures are identified by application program 104 according to method 600 such as for example a dragging gesture, a shaking gesture, and a holding gesture, as will be described with reference to FIG. 21. Turning now to FIG. 21, method 600 for recognizing a multi-touch gesture made by two pointers simultaneously contacting the interactive surface 24 as a holding gesture, a dragging gesture or a shaking gesture is shown. In the event two contact down events are received, corresponding to the two pointers brought into contact with the interactive surface 24, the application program 104 initializes and starts a hold timer, wherein the hold timer calculates the time lapsed until two contact move events are received, or until a threshold value has been reached, thereby identifying a holding gesture (step 602). A check is then performed to determine if two contact move events have been received (step 604). If two contact move events have not been received, the value of the hold timer is compared to a hold time threshold (step 606), and if the value of the hold timer is greater than the hold timer threshold, the gesture is identified as a holding gesture (step 608). If the value of the hold timer is less than the hold timer threshold, the method returns to step 604. In the event two contact move events have been received, the gesture is predicted to be a dragging gesture (step 610). A check is performed to determine if two contact up events have been received (step 612). If two contact up events have been received, the gesture is identified as a dragging gesture (step 614). If two contact up events have not been received, the movement of the pointers is tracked and the number of turns, that is, the number of times the direction of pointer movement has changed approximately 180° during performance of the gesture made is stored in a move counter, and the move counter is compared to a counter threshold, which in this embodiment is set to a value of three (3) (step 616). If the move counter is greater than the counter threshold, that is, there has been greater than three turns made during movement of the pointers, the gesture is identified as a shaking gesture (step 618). If the move counter is less than counter threshold, the time since the last contact move event has been received is calculated and is compared to a gesture timer threshold which in this embodiment is set to a value of four (4) seconds (step 620). If the calculated time is less than the gesture timer threshold, the method returns to step 612. If the calculated time is greater than the gesture timer threshold, the gesture is identified as a dragging gesture (step 622).

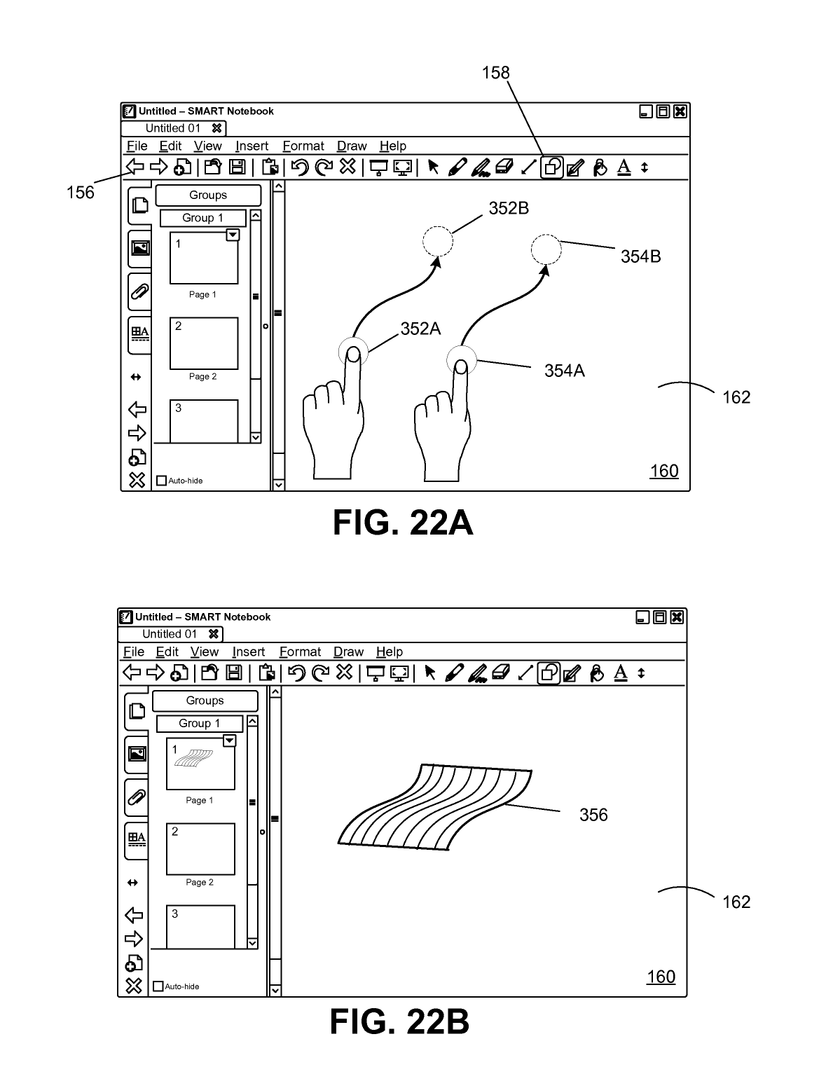

Although method 200 is described as being implemented only in the event the pointers brought into contact with the interactive surface 24 are in the cursor mode, those skilled in the art will appreciate that a method similar to method 200 may be implemented for cursors in the ink mode. As will be appreciated, the implementation of method 200 for pointers operating in the ink mode requires a modified lookup table comprising manipulations associated with the ink mode such as for example creating digital ink, erasing digital ink, etc. FIGS. 22A and 22B illustrate an example of creating digital ink on the canvas zone 160 of the SMART Notebook™ application window based on the use of two pointers, in this case fingers, simultaneously in contact with the interactive surface 24, according to method 200. As can be seen, outline tool button 158 on toolbar 156 is selected and thus any pointers brought into contact with the interactive surface 24 are assumed to be in the ink mode. Two pointer contacts are made on the interactive surface 24 within the canvas zone 160, identified in FIG. 22A as contact down locations 352A and 354A (step 202). The pointer contact type is determined to be simultaneous according to method 230 (step 206), and the number of graphical objects selected on the interactive surface 24 is determined to be one (1) (step 208). Since the pointer contact type is determined to be simultaneous (step 212), the movement of each pointer contact is tracked on the interactive surface 24, as illustrated by the movement from contact down locations 352A and 354A (within canvas zone 160) to contact up locations 352B and 354B (within canvas zone 160), respectively, and the performed gesture is identified as a dragging gesture according to method 240 (step 214). The pointer contact type (simultaneous), the number of graphical objects selected (one) and the graphical object type (canvas) are associated with the graphical object from which the gesture starts (canvas zone 160), the graphical object from which the gesture ends (canvas zone 160), and the gesture performed (dragging), and using a modified lookup table (not shown) for operation in the ink mode, the manipulation to be performed is to create digital ink on the canvas zone 160 (step 218). In this example, it is assumed that the manipulation can be applied to canvas zone 160 (step 220). As a result, the manipulation is then performed on the canvas zone 160 (step 222), wherein digital ink 356 is drawn on the canvas having an outline determined by the paths of the two contacts, as shown in FIG. 22B. The space within digital ink 356 is filled with user selected parameters such as for example color, texture, gradient, opacity, 3D effects, etc. It will be appreciated that digital ink may be drawn using more than two pointers. For example, in the event three pointers are used to create digital ink, the outline determined by the paths of the three pointers may create three equally spaced lines. The space within the outline defined by the first and second pointer contacts may be filled with one type of parameter, such as a blue color, and the space within the outline defined by the second and third pointer contacts may be filled with another type of parameter such as for example a red color.

Although in embodiments described above, two fingers are used to perform the gestures, those skilled in the art will appreciate any number of fingers may be used to perform the same gestures. For example, in another embodiment, a shaking gesture for grouping/ungrouping selected graphical object(s) may be defined as a single pointer applied to a selected graphical object and moving back and forth a set number of times) (e.g. three times within a defined period of time (e.g. four seconds).

As will be appreciated, parameters for recognizing a gesture may be stored in the operating system registry. For example, in a Microsoft® Windows XP system running the SMART Notebook™ application, to identify a shaking gesture according to either of the above-described methods, the parameters stored in the registry are “ShakeContactRange”=“2, 2”, which defines the shaking gesture as a two (2) touch gesture; “ShakeTimeLimit”=“4”, which defines the time threshold as four (4) seconds for the shaking gesture; an ShakeNumber“=”3.0″, which defines that the shaking gesture requires three (3) changes of direction. Parameters for identifying a gesture may be predefined, customized by an authorized user, etc. In another embodiment, the shaking gesture parameters may be redefined as a single touch gesture by defining “ShakeContactRange”=“1, 1”. Alternatively, the shaking gesture may be defined as both a single touch gesture and a two (2) touch gesture by defining “ShakeContactRange”=“1, 2”.

Although methods are described above for identifying a shaking gesture based on the number of times the direction of pointer movement has changed by approximately 180°, those skilled in the art will appreciate that other criteria may also be used to identify a shaking gesture. For example, a speed threshold may be applied such that a pointer moving below the speed threshold would not be identified as a shaking gesture.

Although threshold values are described above as having specific values, those skilled in the art will appreciate that the threshold values may be altered to suit the particular operating environment and/or may be configured by a user. For example, rather than identifying a shaking gesture based on a counter threshold having a value of three (3), the counter threshold may be set to another value such as for example four (4) or five (5).

Although lookup table 290 identifies a selected object cloning manipulation according to both a simultaneous pointer contact type (described above with reference to FIGS. 7A and 7B) and a non-simultaneous pointer contact type (described above with reference to FIGS. 16A to 16C), those skilled in the art will appreciate that only one of the scenarios may be used to identify a selected object cloning manipulation. In this embodiment, the other field in lookup table 290 may be used for a different type of manipulation.

Although manipulations are shown in lookup table 290 according to specific criteria, such as for example the gesture performed, those skilled in the art will appreciate that different manipulations may be associated with different types of gestures. For example, a dragging gesture made from the bottom of the canvas zone towards the center of the canvas zone is described above as being associated with a save file manipulation. However, if desired, the dragging gesture may be alternatively, or additionally associated with a different type of manipulation such as for example scrolling up, printing a file, etc.

Although embodiments described above manipulate graphical objects associated with the SMART Notebook™ application program, those skilled in the art will appreciate that other types of graphical objects may be manipulated such as for example computer program icons, computer program directory icons used in file explorers, computer program shortcut icons, images, bitmap images, JPEG images, GIF images, windows associated with one or more computer programs, visual user interface elements associated with data, digital ink objects associated with one or more computer program applications such as Bridgit™ and MeetingPro™ offered by SMART Technologies ULC, portable document format (PDF) annotations, application program windows such as those associated with a word processor, spreadsheets, email clients, drawing packages, embeddable objects such as shapes, lines, text boxes, diagrams, charts, animation objects such as Flash™, Java™ applets, 3D-models, etc.

Although embodiments are described above where digital ink is drawn within the canvas zone and the space within the digital ink is filled with user selected parameters such as for example color, texture, gradient, opacity, 3D effects, etc., those skilled in the art will appreciate that the digital ink may be drawn with different attributes. For example, in the event a user selects a first and a second color for each respective pointer, the space within the digital ink may be filled with a color gradient smoothly changing from the first to the second color. In another embodiment, in the event a user performs a dragging gesture between two points in the canvas zone, the manipulation may be performed based on a selected drawing tool such as for example an eraser, a polygon tool, a marquee select tool or a spotlight tool. The outline of the digital ink may then be defined based on the selection of the drawing tool. For example, the selection of an eraser may allow the user to drag two pointers in the canvas zone to define the outline of the eraser trace. Any digital ink contained within the outline drawn by the user may then be erased. The selection of a polygon tool may allow a user to drag two pointers in the canvas zone to define the outline of a polygon. The approximate outline of the gesture may be recognized and converted to a polygon shape. The selection of a marquee select tool may allow a user to draw a marquee by dragging two pointers in the canvas zone. Objects enclosed by the marquee may then be selected. The selection of a spotlight tool may allow a user to shade the canvas zone by an opaque layer such that no embedded object on the canvas zone is shown. The user may then drag two pointers on the canvas zone to draw an outline, and any objects positioned within a shape defined by the outline may be revealed.

Those skilled in the art will appreciate that manipulations may also be identified based on the position of the pointer contacts on the interactive surface 24. For example, in the event a contact down event is received at one of the edges of the interactive surface 24 and moved towards the center of the interactive surface, the gesture may be identified as an edge to middle gesture. In this example, a manipulation associated with the gesture may be an overall system operation such as for example opening a file, shutting down the general purpose computing device, etc.

Although various types of manipulations are described in embodiments above, those skilled in the art will appreciate that other type of manipulations may be used such as for example cloning, grouping, ungrouping, locking, unlocking, cloning with resizing, clearing, converting, outlining, opening, selecting, etc.

Although pointer contacts are described as being made by a user's finger or fingers, those skilled in the art will appreciate that other types of pointers may be used such as for example a cylinder or other suitable object, a pen tool or an eraser tool lifted from a receptacle of the tool tray.

In another embodiment, finger movements may be tracked across two or more interactive surfaces forming part of a single IWB. In this embodiment, finger movements may be tracked in a manner similar to that described in U.S. Patent Application Publication No. 2005/0259084 to Popovich et al. entitled “TILED TOUCH SYSTEM”, assigned to SMART Technologies ULC, the disclosure of which is incorporated herein by reference in its entirety.

Although not shown above, those skilled in the art will appreciate that one or more indicators may be used to show a gesture such as for example phantom objects, lines, and squares of any appropriate size.

Although in embodiments described above, the IWB comprises one interactive surface, in other embodiments, the IWB may alternatively comprise two or more interactive surfaces, and/or two or more interactive surface areas. In this embodiment, each interactive surface, or each interactive surface area, has a unique surface ID. IWBs comprising two interactive surfaces on the same side thereof have been previously described in U.S. Patent Application Publication No. 2011/0043480 to Popovich et al. entitled “MULTIPLE INPUT ANALOG RESISTIVE TOUCH PANEL AND METHOD OF MAKING SAME”, assigned to SMART Technologies ULC, the disclosure of which is incorporated herein by reference in its entirety.

The application program may comprise program modules including routines, object components, data structures, and the like, and may be embodied as computer readable program code stored on a non-transitory computer readable medium. The computer readable medium is any data storage device that can store data. Examples of computer readable media include for example read-only memory, random-access memory, CD-ROMs, magnetic tape, USB keys, flash drives and optical data storage devices. The computer readable program code may also be distributed over a network including coupled computer systems so that the computer readable program code is stored and executed in a distributed fashion.

Although in embodiments described above, the IWB is described as comprising machine vision to register pointer input, those skilled in the art will appreciate that other interactive boards employing other machine vision configurations, analog resistive, electromagnetic, capacitive, acoustic or other technologies to register pointer input may be employed.

For example, products and touch systems may be employed such as for example: LCD screens with camera based touch detection (for example SMART Board™ Interactive Display—model 8070i); projector based IWB employing analog resistive detection (for example SMART Board™ IWB Model 640); projector based IWB employing a surface acoustic wave (WAV); projector based IWB employing capacitive touch detection; projector based IWB employing camera based detection (for example SMART Board™ model SBX885ix); table (for example SMART Table™—such as that described in U.S. Patent Application Publication No. 2011/069019 assigned to SMART Technologies ULC of Calgary, the entire contents of which are incorporated herein by reference); slate computers (for example SMART Slate™ Wireless Slate Model WS200); podium-like products (for example SMART Podium™ Interactive Pen Display) adapted to detect passive touch (for example fingers, pointer, etc, —in addition to or instead of active pens); all of which are provided by SMART Technologies ULC.

Other types of products that utilize touch interfaces such as for example tablets, smartphones with capacitive touch surfaces, flat panels having touch screens, track pads, interactive tables, and the like may embody the above described methods.

Although embodiments have been described above with reference to the accompanying drawings, those of skill in the art will appreciate that variations and modifications may be made without departing from the scope thereof as defined by the appended claims.

What is claimed is:

1. A method comprising:
generating at least two input events in response to at least two contacts made by pointers on an interactive surface at a location corresponding to at least one graphical object;
determining a pointer contact type associated with the at least two input events;
determining the number of graphical objects selected;
identifying a gesture based on the movement of the pointers;
identifying a manipulation based on pointer contact type, number of graphical objects selected, movement of the pointers, and graphical object type; and
performing the manipulation on the at least one graphical object.

2. The method of claim 1 wherein the at least two contacts on the interactive surface are made by at least two fingers or at least two pen tools configured to a cursor mode.

3. The method of claim 1 wherein identifying the manipulation comprises looking up the pointer contact type, number of graphical objects selected, the graphical object type, and the identified gesture in a lookup table.

4. The method of claim 3 wherein the lookup table is customizable by a user.

5. The method of claim 1 wherein the graphical object type is one of an embedded object, a file tab, a page thumbnail and a canvas zone.

6. The method of claim 5 wherein when the graphical object type is an embedded object, the manipulation is one of cloning, grouping, ungrouping, locking, unlocking and selecting.

7. The method of claim 5 wherein when the graphical object type is a file tab, the manipulation is cloning.

8. The method of claim 5 wherein when the graphical object type is a page thumbnail, the manipulation is one of cloning, moving to the next page thumbnail, moving to the previous page thumbnail, and cloning to resize to fit to a canvas zone.

9. The method of claim 5 wherein when the graphical object type is a canvas zone, the manipulation is one of moving to the next page, moving to the previous page, cloning, opening a file and saving a file.

10. The method of claim 1 wherein the pointer contact type is one of simultaneous and non-simultaneous.

11. The method of claim 10 wherein when the pointer contact type is simultaneous, the gesture identified is one of dragging, shaking and holding.

12. The method of claim 10 wherein when the pointer contact type is non-simultaneous, the gesture identified is one of hold and drag, and hold and tap.

13. The method of claim 1 further comprising identifying a graphical object on which the gesture starts, and identifying a graphical object on which the gesture ends.

14. The method of claim 13 wherein identifying the manipulation comprises looking up the pointer contact type, number of graphical objects selected, the graphical object type, the graphical object on which the gesture starts, the graphical object on which the gesture ends and the identified gesture in a lookup table.

15. The method of claim 14 wherein the lookup table is customizable by a user.

16. The method of claim 14 wherein the graphical object type is one of an embedded object, a file tab, a page thumbnail and a canvas zone.

17. An interactive input system comprising:
an interactive surface; and
processing structure configured to receive at least two input events in response to at least two contacts made by pointers on the interactive surface at a location corresponding to at least one graphical object, said processing structure being configured to determine a pointer contact type associated with the at least two input events, determine the number of graphical objects selected, identify a gesture based on the movement of the pointers, identify a manipulation based on the pointer contact type, number of graphical objects selected, movement of the pointers, and graphical object type, and perform the manipulation on the at least one graphical object.

18. The interactive input system of claim 17 wherein in order to identify the manipulation, the processing structure is configured to look up the pointer contact type, number of graphical objects selected, the graphical object type, and the identified gesture in a lookup table.

19. The interactive input system of claim 18 wherein the graphical object is one of an embedded object, a file tab, a page thumbnail and a canvas zone.

20. The interactive input system of claim 19 wherein when the graphical object type is an embedded object, the manipulation is one of cloning, grouping, ungrouping, locking, unlocking and selecting.

21. The interactive input system of claim 19 wherein when the graphical object type is a file tab, the manipulation is cloning.

22. The interactive input system of claim 19 wherein when the graphical object type is a page thumbnail, the manipulation is one of cloning, moving to the next page thumbnail, moving to the previous page thumbnail, and cloning to resize to fit to a canvas zone.

23. The interactive input system of claim 19 wherein when the graphical object type is a canvas zone, the manipulation is one of moving to the next page, moving to the previous page, cloning, opening a file and saving a file

24. The interactive input system of claim 17 wherein the pointer contact type is one of simultaneous and non-simultaneous.

25. The interactive input system of claim 24 wherein when the pointer contact type is simultaneous, the gesture identified is one of dragging, shaking and holding.

26. The interactive input system of claim 24 wherein when the pointer contact type is non-simultaneous, the gesture identified is one of hold and drag, and hold and tap.

27. The interactive input system of claim 17 wherein the processing structure is further configured to identify a graphical object on which the gesture starts, and identify a graphical object on which the gesture ends.

28. The interactive input system of claim 25 wherein in order to identify the manipulation, the processing structure is configured to look up the pointer contact type, number of graphical objects selected, the graphical object type, the graphical object on which the gesture starts, the graphical object on which the gesture ends and the identified gesture in a lookup table.

29. The interactive input system of claim 18 wherein the lookup table is customizable by a user.

30. The interactive input system of claim 28 wherein the lookup table is customizable by a user.

31. The interactive input system of claim 17 wherein the at least two contacts on the interactive surface are made by at least two fingers or at least two pen tools configured to a cursor mode.

32. A non-transitory computer readable medium embodying a computer program for execution by a computing device, the computer program comprising:
program code for generating at least two input events in response to at least two contacts made by pointers on an interactive surface at a location corresponding to at least one graphical object;
program code for determining a pointer contact type associated with the at least two input events;
program code for determining the number of graphical objects selected;
program code for identifying a gesture based on movement of the pointers;
program code for identifying a manipulation based on pointer contact type, number of graphical objects selected, movement of the pointers, and graphical object type; and
program code for performing the manipulation on the at least one graphical object.
